(19) United States
(12) Patent Application Publication
(10) Pub. No.: US 2026/0080486 A1
(43) Pub. Date: Mar. 19, 2026

(54) AI Driven Hospitality Services and Management

(71) Applicants: Daniel Lee, Irvine, CA (US); Nikhil Jha, New Delhi (IN)

(72) Inventors: Daniel Lee, Irvine, CA (US); Nikhil Jha, New Delhi (IN)

(21) Appl. No.: 18/885,562

(22) Filed: Sep. 14, 2024

(51) Int. Cl. G06Q 50/12; G06Q 10/0631; G06Q 30/015

(52) U.S. Cl. CPC G06Q 50/12; G06Q 10/063114; G06Q 30/015

(57) ABSTRACT

Systems, methods, and other embodiments associated with a computer-implemented method for obtaining and processing a ticket generated by an AI Chatbot associated with a guest of an establishment, the ticket configured to include a guest message. In one embodiment, a method includes determining, by a machine learning model, a task to be completed based on the guest message and one or more departments associated with the establishment for handling the task, assigning, using an iterative algorithm, the generated ticket to one or more attendant devices for task completion, each attendant device belonging to a staff member of the establishment, communicating, via the iterative algorithm, to the assigned one or more attendant devices, a request for completion of the task, and displaying, on a graphical user interface (GUI) display, at least one of the one or more assigned tasks, one or more generated tickets, one or more tasks to be completed.

### TECHNICAL FIELD

The embodiments generally relate to methods and systems for streamlining and automating hospitality services and management for guests and human users, and more particularly, relates to methods and systems for artificial intelligence driven hospitality management and services.

### BACKGROUND

In recent years, the hospitality and travel industries have enjoyed significantly increased demand due to consumer desire to explore new destinations in groups and stay for longer. In order to gain their business and provide consumers with memorable experiences, hospitality and travel services may steadily increase their offerings of experiences and activities for families, couples, and individuals to enjoy. Consequently, consumers have come to expect a certain level of service from lodgings, from offering unique venues, amenities, foods and cuisines to all-inclusive hospitality services allowing them to relax and be comfortable while being adventurous during their stay.

With ever changing menus, layouts, venues, events and hospitality settings, it can become challenging for a hotel or resort to adequately serve each guest's need throughout the establishment throughout the day. Further, it can become challenging, inconvenient, or overwhelming for new guests to navigate an unfamiliar or crowded establishment to find food, services, or attendants to help with their needs. In order to consistently provide food, amenities, and services to guests, establishments can often be forced to limit food selections, amenities, and services to ensure services, food, and venues are manageable, accessible, and operating for all guests. However, this is often less than ideal as it prevents servicing of individual guest needs and providing them with a memorable and pleasant experience that translates to good reviews, repeated business, referrals, and increased revenue. With the steady influx of travelers and guests visiting hotels and resorts throughout the year, many establishments can improve common services and management practices by having a hospitality management system that promptly addresses a guest's needs at all times and improves guest engagement with the hotel or resort staff and managers thereby avoiding delays, errors, miscommunication, and inefficiencies in providing hospitality services to guests.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale. A complete understanding of the present embodiments and the advantages and features thereof will be more readily understood by reference to the following detailed description when considered in conjunction with the accompanying drawings wherein:

FIG. 1 illustrates one embodiment of a computing system configured to provide an AI driven hospitality services and management system for automating and streamlining hospitality services for guests and hospitality management for attendants and managers of an establishment;

FIG. 2 illustrates one embodiment of a network environment configured for implementing the AI driven hospitality services and management system for automating and streamlining hospitality services and management of FIG. 1;

FIG. 3 illustrates one embodiment of a method performed by the system of FIG. 1 for automating and streamlining hospitality services and management;

FIGS. 4A-4B illustrate one embodiment of an overview of a run-time or operational method associated with the system of FIG. 1 for operations, communications, and transactions made within the AI driven hospitality services and management system;

FIG. 5A is one embodiment of a schematic illustration of an AI Chatbot of the AI driven hospitality services and management system, the AI Chatbot being displayed in a graphical user interface (GUI) of a guest device within the AI driven hospitality services and management system associated with FIG. 1;

FIG. 5B is one embodiment of a schematic illustration of a manager's dashboard displaying tasks and tickets generated by the AI Chatbot as displayed in a graphical user interface (GUI) of a manager device or login within the AI driven hospitality services and management system associated with FIG. 1;

FIG. 5C is one embodiment of a schematic illustration of a welcome screen or main screen allowing an attendant or manager of an establishment to log into the AI driven hospitality services and management system associated with FIG. 1;

FIG. 5D is one embodiment of a schematic illustration of a manager's dashboard displayed in a graphical user interface (GUI) of a manager device or login within the AI driven hospitality services and management system associated with FIG. 1;

FIGS. 5E-5G is one embodiment of a schematic illustration of a manager's dashboard displaying tasks and tickets generated by guests of the establishment pertaining to one or more departments as displayed in a graphical user interface (GUI) of a manager device or login within the AI driven hospitality services and management system associated with FIG. 1;

FIG. 5H is one embodiment of a schematic illustration of a manager's chat screen displaying a listing of chat sessions with attendants at an establishment pertaining to one or more departments as displayed in a graphical user interface (GUI) of a manager device or login within the AI driven hospitality services and management system associated with FIG. 1;

FIGS. 5I-5J is one embodiment of a schematic illustration of an attendant or manager's profile and history screen displaying a listing of guest information such as guest generated tickets, tasks, room number, and times at an establishment displayed in a graphical user interface (GUI) of an attendant or manager device or login within the AI driven hospitality services and management system associated with FIG. 1;

FIG. 5K is one embodiment of a schematic illustration of a manager's screen displaying ticket options and task assignment for a guest at an establishment as displayed in a graphical user interface (GUI) of a manager device or login within the AI driven hospitality services and management system associated with FIG. 1;

FIG. 6A is one embodiment of a schematic illustration of an attendant's screen displaying ticket options and task assignment for a guest at an establishment as displayed in a graphical user interface (GUI) of an attendant device or login within the AI driven hospitality services and management system associated with FIG. 1;

FIG. 6B is one embodiment of a schematic illustration of an attendant's dashboard screen displaying ticket and task assignments for guests at an establishment as displayed in a graphical user interface (GUI) of an attendant device or login within the AI driven hospitality services and management system associated with FIG. 1;

FIG. 6C is one embodiment of a schematic illustration of an attendant's dashboard screen displaying the progress of ticket and task assignments for guests at an establishment as displayed in a graphical user interface (GUI) of an attendant device or login within the AI driven hospitality services and management system associated with FIG. 1;

FIG. 7A is one embodiment of a schematic illustration of all pending tickets for guests at an establishment displayed in a graphical user interface (GUI) of a manager's device or login within the AI driven hospitality services and management system associated with FIG. 1;

FIG. 7B is one embodiment of a schematic illustration of all new tickets for guests at an establishment displayed in a graphical user interface (GUI) of a manager's device or login within the AI driven hospitality services and management system associated with FIG. 1;

FIGS. 8A-8B is one embodiment of a schematic illustration of example services and menus for guests at an establishment displayed in a graphical user interface (GUI) of a manager's device or login within the AI driven hospitality services and management system associated with FIG. 1; and

FIG. 9 illustrates an embodiment of a computing system configured with the example systems and/or methods disclosed.

### DETAILED DESCRIPTION

Systems and methods are described herein as associated with a computer-implemented method for automating and streamlining hospitality services for guests and hospitality management for attendants and managers of an establishment, in one embodiment. The computer-implemented method may include an AI driven hospitality services and management system having an AI Chatbot for generating and configuring a ticket (i.e., task(s) creation), one or more Large Language Models (LLMs) for processing and handling the generated ticket (i.e., task(s) analysis and routing), and an iterative algorithm for managing and monitoring the ticket and task(s) to completion (i.e., attendant, manager, or department allocation, assignment, management and monitoring). A network for the AI driven hospitality services and management system may be configured whereby personnel devices (i.e., attendant, staff, and managers devices) for each department, service, or venue are communicably coupled with each component and each stage of the AI driven hospitality services and management system such that personnel can view and/or participate in one or more stages of a work order, for example, task creation, task analysis and routing, ticket/task management and monitoring, task status updates, and task completion.

In one embodiment, the AI driven hospitality services and management system may provide an AI Chatbot to interact with guests allowing them to promptly request services or information, place orders, make requests, provide information such as health or dietary information, and the like. By understanding a guest's request and services and products offered by an establishment, for example, the AI Chatbot may efficiently generate work order tickets for guests based on their message and/or request thereby routing guests'requests to the appropriate staff, manager, and/or departments through the property or establishment throughout their stay ensuring their requests are promptly addressed. The AI Chabot may configure and re-evaluate/re-configure each ticket generated by a guest based on one or more conversations or chat sessions with the guest.

In some embodiments, the AI driven hospitality services and management system may provide one or more Large Language Model (LLMs) to analyze each generated ticket to determine one or more tasks requested/required thereby automatically creating a work order for the guest's request(s). Further, the one or more Large Language Model (LLMs) may access a database for the establishment containing, for example but limited to, personnel, staff, managers, services, menus, restaurants, and departments to determine the appropriate destination (e.g., personnel and/or department) to handle or process the work order. As an example, upon determining the appropriate personnel and/or department for handling or completing the guest's work order, the guest may be given access to communicate with the determined staff, managers, services, and departments for the establishment throughout their stay ensuring their requests are promptly addressed.

In some embodiments, the AI driven hospitality services and management system may provide an iterative algorithm to efficiently assign a ticket or work order based on various factors personnel workload, task complexity, and personnel proximity to the task request such that a task or work order is assigned to the appropriate personnel for prompt response and completion. In certain embodiments, the iterative algorithm may auto-assign tickets or work orders to the appropriate personnel and/or department thereby automating the creation and assignment of work order tickets and reducing the manual workload on staff to allow them to focus on high-value tasks. In some embodiments, the iterative algorithm may assign tickets or work orders to the appropriate manager, staff, and/or department to delegate the work to appropriate personnel. Further, the iterative algorithm may monitor personnel workflow, tasks, and assigned tickets throughout the day to efficiently handle personnel workflow management by taking into consideration various factors, for example, personnel location, department, proximity, and current workload to assign tasks efficiently thereby avoiding delays, errors, miscommunication, and inefficiencies.

The AI driven hospitality services and management system leverages Large Language Models (LLMs) to create and assign work order tickets efficiently within a property thereby facilitating seamless communication between guests and appropriate personnel and property services to ensure prompt task assignment and delivery of products and services and fulfilment of guest requests to provide an enhanced guest experience. Moreover, the system supports communication and task management across various departments, including housekeeping, engineering, and dining, making it a versatile solution for different hospitality settings enabling guests to connect directly to the associate completing the task without a coordinator.

In certain embodiments, various services, transactions, operations, and solutions are also contemplated. For example, the AI driven hospitality services and management system may provide support for monetary transactions for guests and menu management for attendants or managers, making it a comprehensive solution for hospitality properties. As another example, the AI driven hospitality services and management system may provide a desktop or front-desk accessible computing device that enables administrators/managers to manage associates, food and beverage menu items, and other administrative tasks. Certain embodiments of the AI driven hospitality services and management system are contemplated for example, incorporating multiple menus (in-room dining, poolside, etc.,) within the AI Chatbot or machine learn models making it easy to manage and update offerings and allow guests to share their location and order to nearby services, facilities, personnel, or restaurants to fulfill. Moreover, the AI driven hospitality services and management system may collect and analyze data on service requests and task completions providing establishments, personnel, and service providers with valuable insights for improving operations and guest services. Further, the AI driven hospitality services and management system may store data that can be later used to assist establishments with predicting and preventing potential issues, reducing downtime and maintenance costs.

Previous systems and methods for providing hospitality services and management have several significant shortcomings. Present systems often rely on guests waiting in line at the front desk or repeatedly calling to access a front desk representative to handle their questions, feedback, and requests. With present systems, it can become inconvenient or overwhelming for guests to navigate an unfamiliar or crowded establishment to find food, services, or attendants to help with their needs. Further, it can become challenging for a hotel or resort to adequately serve each guest's need throughout the establishment throughout the day. Many establishments can improve common services and management practices by having a hospitality management system that promptly addresses a guest's needs at all times and improves guest engagement with the hotel or resort staff and managers thereby avoiding delays, errors, miscommunication, and inefficiencies in providing hospitality services to guests.

With the present systems and methods, an AI driven hospitality services and management system allows guests to instantly communicate with an AI Chatbot a request for information, products, or services. The AI Chatbot the provides guest messages to a content analysis and processing system within the AI hospitality services and management that obtains real-time personnel resources and facility resources from a facility database to quickly handle guest requests and address guest needs. These and other features are described herein with reference to the attached figures.

### System Embodiment

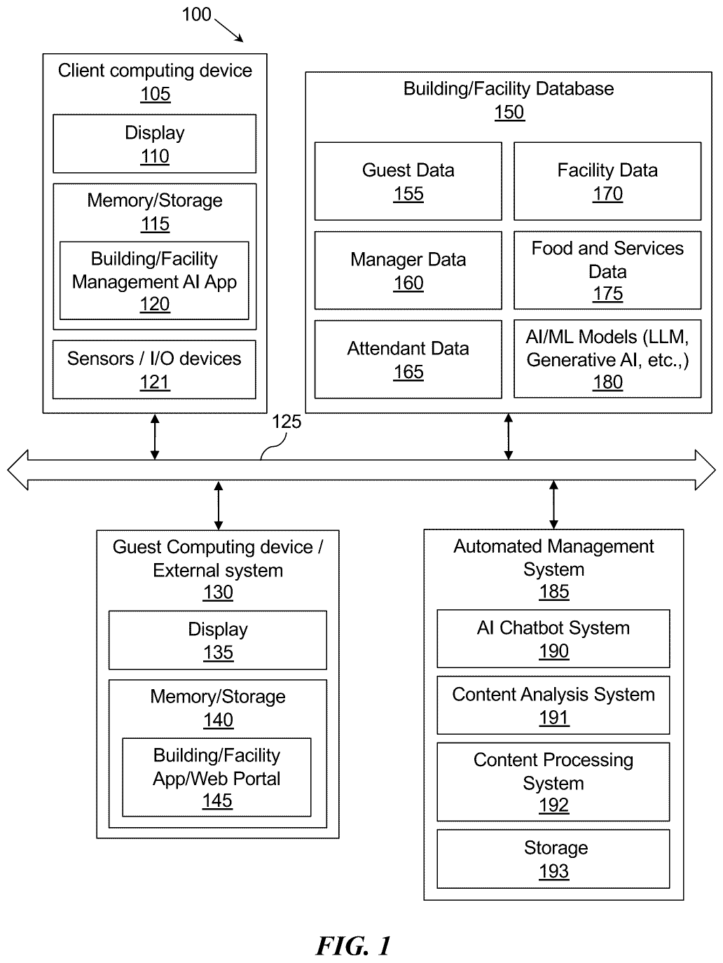

With reference to FIG. 1, one embodiment of a computing environment is illustrated that is configured with an AI driven hospitality services and management system 100. In one embodiment, the AI driven hospitality services and management system 100 is configured to include a client computing device 105, a guest or external computing device 130, a facility database 150, and an automated management system 185 that includes an AI chatbot system 190, a content analysis system 191, a content processing system 192, and storage 193. In some embodiments, data for generating each ticket and each task may be stored on at least one of a storage 193 of the automated management system 185, the facility database 150, storage 105 of client computing device 105, and storage 140 of external computing device 130.

In one embodiment, the AI driven hospitality services and management system 100 is configured to create a guest ticket at an establishment by obtaining information and/or requests from the guest through one or more conversations with the guest (e.g., chat sessions with a guest). The guest ticket may be configured to include one or more guest requests, guest messages, guest information, information about the establishment, service information/requests, and the like as is contemplated for guest requests at a resort, hotel, establishment, building, facility, and the like. The one or more guest conversations may be facilitated by an AI Chatbot, for example, through a natural language dialog with the guest for creating and configuring the guest ticket. In one embodiment, the AI driven hospitality services and management system may be configured to analyze the content of the generated guest ticket to determine one or more task requests and one or more related or relevant personnel or departments for handling each determined task. The AI driven hospitality services and management system may be further configured to process, monitor, and manage the task to completion by automatically assigning the generate ticket(s) and task(s) to the appropriate personnel (e.g., staff, attendant, manager) or department and monitoring their progress.

In one embodiment, the automated management system 185 may include, but is not limited to, a computer application/program that includes one or more algorithms configured to generate tickets, analyze tickets, and process tickets based on one or more guest chats or conversations as described herein. The algorithm comprises a set of algorithms and/or functions that generate tickets, analyze tickets, and process tickets based on information and instructions provided by the content retrieved by the automated management system. As an example, the content may include a guest request or instructions that when processed by the automated management system provides actionable information for the establishment, attendants, staff, managers, service providers, and so forth for completing a task or guest request.

Similarly, the external computing device 130 may include, but is not limited to, a computer application/program that includes one or more algorithms configured to generate tickets, analyze tickets, and process tickets based on information and instructions (i.e., content) provided by the guest and/or obtained from the external computing device 130. Moreover, the external computing device 130 may include, but is not limited to, a computer application/program that includes one or more algorithms configured to generate tickets, analyze tickets, and process tickets based on information and instructions provided by the content retrieved by the automated management system. The algorithm comprises a set of algorithms and/or functions that generate tickets, analyze tickets, and process tickets based on information and instructions provided by the content retrieved by the automated management system

In one embodiment, the ticket/task may be encrypted by the automated management system 185, client computing device 105, or guest computing device 130 such that the privacy and anonymity of guest information, requests, and tasks are maintained, and only proprietary applications on the client computing device, guest computing device, or automated management system 185 can view, display, edit and/or process the contents of the ticket/task.

As shown in FIG. 1, the computing environment (e.g., a cloud-computing environment) of the AI driven hospitality services and management system 100 may provide access to remote client devices such as client computing device 105 through one or more network communication channels 125 (e.g., a communication bus, wireless communication, wired networks, combinations of channels, etc.). A remote client device may access and communicate raw data (e.g., guest data 155) via a graphical user interface to the AI driven hospitality services and management system 100, as well as run programs, software, algorithms, models, and functions through the AI driven hospitality services and management system 100. A client device may access the automated management system 185, the facility database 150, and the AI driven hospitality services and management system 100 via a graphical user interface through display 110 and a building/facility management AI application 120 stored on or running from memory/storage device 115 to retrieve, update, edit, and process content pertaining to a guest, guest services, and other operations and services associated with or provided by the establishment. In some embodiments, the client computing device 105 may be configured as a service provider or attendant/manager device whereby the building/facility management AI application 120 may communicate with other client computing devices 105 and guests or external computing devices 130 communicably coupled with the AI driven hospitality services and management system 100, as well as retrieve content pertaining to a guest ticket, task or request, and information about services and the establishment from the facility database 150, the automated management system 185, or any combination thereof as described herein.

Moreover, the client computing device 105 may include one or more sensors/input/output (I/O) devices 121 and associated software, firmware, or applications as needed for identity verification and visual or image verification of an individual, event, or completed task. In one embodiment, the sensors/input/output (I/O) devices 121 may include, for example, optical sensors, cameras, biometric sensors, near/passive infrared (IR) sensors, fingerprint sensors, microphones, accelerometers, and other sensors as is readily contemplated in the art for identity and image verification. In one embodiment, facial recognition and/or two step authentication, authentication codes, and secure rolling codes, or any combination thereof may be required to access one or more of the client computing devices 105, the building/facility management AI application 120, and the AI driven hospitality services and management system 100.

With reference again to FIG. 1, the computing environment (e.g., a cloud-computing environment) of the AI driven hospitality services and management system 100 may provide access to an external system or computing device such as external computing device 130 through one or more network communication channels 125 (e.g., a communication bus, wireless communication, wired networks, combinations of channels, etc.). The external computing device 130 may include a facility application 145 to access resources provided for guests by the establishment through the AI driven hospitality services and management system 100. In certain embodiments, the facility application 145 may be a mobile application, a web portal, an integrated messaging service, or any combination thereof. As an example, the external computing device 130 may obtain via the facility application 145 information about services, products, events, restaurants, and offers provided by or associated with the establishment.

In one embodiment, the facility application 145 may provide guests with access to the AI chatbot system 190 of the automated management system 185. The AI chatbot system 190 may be configured to obtain guest information, for example, room number, check in time, check out time, primary language, age, gender, dietary and health information or concerns, vehicle information, flight or transportation information, parking information, payment information, and so forth. The guest information may be appended to a guest request. The guest request may include, for example, room requests and information, transportation requests and information, dinning information, food and services menus and ordering, entertainment venues and events, bar and club locations and events, family or children's events, activities, and programs, and the like. The guest request may be initiated through one or more conversations with the AI chatbot system 190. In some embodiments, the external computing device 130 may be configured as a guest device whereby the facility application 145 may communicate with client computing devices 105 and other guests or external computing devices 130 communicably coupled with the AI driven hospitality services and management system 100, as well as retrieve content pertaining to a guest ticket, task or request, and information about services and the establishment from the facility database 150, the automated management system 185, or any combination thereof as described herein.

In certain embodiments, the facility application 145 and/or the automated management system 185 may learn the guest's unique tastes and preferences and analyze facility database 150 to help recommend or discover personalized recommendations for services, restaurants, events, shopping, tourism, sight-seeing, transportation, and so forth. Thus, the automated management system 185 may be configured as is contemplated to save personnel time and resources in answering common guest questions and addressing frequently made requests that typically take valuable time from staff, attendants, and managers. In certain embodiments, the AI Chatbot system 190 may generate a guest ticket in response to a verbal communication between the guest and the AI Chatbot where the guest to AI Chatbot verbal communication includes at least one of a user query, a user request, and a verbal command.

With reference to FIG. 1, the computing environment (e.g., a cloud-computing environment) of the AI driven hospitality services and management system 100 includes a facility database 150. The facility database 150 may include guest data 155, manager data 160, attendant data 165, facility data 170, food and services data 175, and AI/ML models 180 database. The guest data 155 may include user credentials, preferences, login, customer information (e.g., services, orders, etc.,), reservation, and room information, service orders, tastes, allergy and dietary information, health information and concerns, nutritional requirements, age, gender, geographic location, payment information, language preference, identity verification information, and the like. The manager data 160 may include user credentials, geographic location, identity verification information, pay information, workload and guest/ticket assignment information, department assignment, age, gender, language information, department information. The attendant data 165 may include user credentials, geographic location, identity verification information, pay information, workload and guest/ticket assignment information, department assignment, age, gender, language information, department information. The guest data 155, manager data 160, and attendant data 165 may include textual, visual, or audio data communicated to the AI driven hospitality services and management system 100 or stored in the facility database 150 by the user as part of a user request, user profile, guest to AI chatbot communication, user settings, or any combination thereof.

The facility database 150 includes facility data 170 that may be accessed and modified/updated by the AI driven hospitality services and management system 100, or client computing device 105. The facility data 170 may include a listing of every space and their corresponding geographic location, description, and product/services offering associated with, or proximate to, the establishment in textual and visual format (e.g., floor level, heading, location on a facility map, GPS location, delivery time, transportation options, photos, 3D image/walkaround, etc.,). The facility data 170 may include a listing of each, for example, lobby, guest rooms, restaurants, bars, hallways, indoor guest facilities (e.g., spa, massage, pool, jacuzzi, etc.,), walkways, entrances, exits, parking structures and facilities, indoor and outdoor facilities and services (concierge, staff, housekeeping, engineering, dining, transportation, room service, etc.,). The facility data 170 may further include for each facility and service, facility or service names, service options and rates, menu prices, order options, as well as names, geographic locations, workload and work hours and shifts of service staff for indoor and outdoor facilities and services. Moreover, as is readily contemplated, each staff member of an indoor and outdoor facility or service may be assigned an attendant device (or manager device) and assignable to a guest task or guest ticket as determined by the automated management system 185. Further, the automated management system 185 may attempt to streamline and automate the completion of a guest task/request for a service, product, or information from one or more staff members by determining the proper personnel to handle the guest task based data from the facility database 150 and based on prior guest requests and responses. Thus, the automated management system 185 may provide the information, service, or response that the guest requires by collecting information from the facility database and assigning the guest to one or more departments and/or personnel for completing the guest task/request.

The facility database 150 may include food and services data 175 that may be accessed and modified/updated by the AI driven hospitality services and management system 100, or client computing device 105. The food and services data 175 may include a listing of every menu item, and food/service location associated with, or proximate to, the establishment. The AI Chatbot system 190 may retrieve and itemize and/or list each menu item or service available for the guest based on data from the facility database 150 and based on prior guest requests and responses. Similarly, the food and services data 175 may include a listing of each service option or menu of, for example, a restaurant, bar, guest amenity, club, entertainment venue, concert or sports venue, or other indoor, outdoor, or proximate event as is contemplated. The food and services data 175 may further include a listing of product/services offered, a description of the provider and corresponding geographic location that is associated with, or proximate to, the establishment in textual and visual format (e.g., floor level, heading, location on a facility map, GPS location, delivery time, transportation options, photos, 3D image/walkaround, etc.,).

The facility database 150 may include an AI/ML models 180 database accessible by the automated management system 185. In one embodiment, the AI/ML models may be stored and executed from storage 193. The AI/ML model 180 database may include various LLM models, generative AI, or natural language processing (NLP) that may be used by the automated management system 185 to generate guest tickets/tasks in a conversation mode with the guest via the AI Chabot system 190, and to generate specific tasks for attendants or managers, as well as create requests, orders, or provide information for specific services, products, events, menus, restaurants, entertainment venues, etc., as described herein, via the content analysis system 191. The content analysis system 191 may be configured to automatically generate and assign one or more specific tasks to the appropriate attendant(s) or manager(s), as well as fulfill requests, place orders, or obtain and provide information for specific services, products, events, menus, restaurants, entertainment venues, etc., as described herein. In certain embodiments, the content analysis system 191 may export service or product orders to a guest's/user's third-party application, as an example. The facility database 150 may further collect and store guest requests and tasks as guest data 155 and aggregate and process the guest data using different statistical models to obtain insight, trends, or other information from individual and aggregate guest requests and responses.

As described above, the automated management system 185 may be configured to include an AI chatbot system 190, a content analysis system 191, a content processing system 192, and storage 193. The AI chatbot system 190, the content analysis system 191, the content processing system 192, may each include, but not be limited to, a computer application/program that includes one or more algorithms configured to create, configure, and modify tickets (i.e., data blocks for tickets) based on at least one of user client 105 input, guest client 130 input, configuration, settings, or data from building/facility management AI application 120 and/or facility application 120, or data from database 130, analyze the contents of each data block of each ticket, distribute each ticket (i.e., data block for each ticket) to one or more client computing devices 105, respectively, as well as storing each ticket (i.e., data block for each ticket) in database 130 or storage 193.

In one embodiment, the AI chatbot system 190 may be configured to provide a custom guest chat interface that enables an interactive AI chatbot to engage with different users in different settings, for example, different types of guests (e.g., rewards members, returning guests, new guests, etc.,), establishments (hotels, resorts, homes, apartments, condos, etc.,), locations, seasons, and the like. The AI chatbot may be customized for each user/settings type to ensure relevant, natural conversations that adapt based on guest responses. In some embodiments, the AI chatbot system 190 may be powered by an artificial intelligence (AI) model configured to ask suitable questions and follow-up questions based on guest request, location, time of day, age, as well as responses from previous chats, requests, visits, preferences, or conversations. Further, the AI chatbot may be configured to include or select from various large language model (LLM) models or generative AI to facilitate natural conversational questioning. The current NLP engine is powered by, for example, OpenAI's GPT-4o mini to enable advanced conversational abilities. The NLP engine may provide an interactive chatbot with conversational question-asking, customization of queries adapted based on individual responses, a backend powered by OpenAI GPT-3.0, 3.5, 4.0, etc., for advanced NLP. Any suitable AI model or a combination of AI models may be used for the AI chatbot system 190, the content analysis system 191, or the content processing system 192 when emphasis or needs change between scale and depth and efficiency and performance. For example, Llama created by Meta, for example, Llama 3.1 may be used in place of or in combination with GPT 4.0. Llama 3.1 or any similar AI model or combination of models may be used in order to understand and generate human-like language, answer questions and provide information, summarize long texts into short texts, translate between languages, and converse and respond to user input in a helpful and engaging way, process and analyze large amounts of data, learn and improve over time, and understand and respond to nuance and context-specific queries.

The external computing device 130 may execute or initiate a chat session or continue a conversation with the AI chatbot system 190 through the facility application 145 whereby the AI chatbot system 190 generates a guest ticket containing one or more requests, messages, or tasks. In some embodiments, the automated management system 185 may analyze a guests chat session, conversation, or ticket/task status to determine whether to re-initiate a chat session or continue a conversation with the AI chatbot system 190 or whether to hand-off the guest to a client computing device 105 thereby connecting the guest with an attendant or manager of the establishment. As an example, the content analysis system 191 may determine whether additional information is necessary from the guest in order to place or complete an order, properly assign the guest ticket/task to the appropriate department or personnel for completion, or determine the location, priority, or urgency of the guest request.

The AI chatbot data, AI models, guest data and settings, establishment data and settings may be retrieved from the automated management system 185 and the facility database 150. In certain embodiments, each guest chat session or conversation can be collected and analyzed, for example, to obtain insights for improving operations and guest services, improving the AI Chatbot interface or interactions, the establishment and guest services, and seasonal trends and demand for guests, services, and products. Moreover, the collected guest data can assist managers, staff, and establishment owners in predicting and preventing potential issues and reducing downtime and maintenance costs.

The AI driven hospitality services and management system 100 is configured to analyze the contents of raw data (e.g., guest chat sessions or conversations) to determine programs, software, algorithms, models, and functions for processing the raw data to determine one or more appropriate facility resources from the facility database 150 for handling the guest request via a content analysis system 191. The AI driven hospitality services and management system 100 is further configured to determine content distribution (e.g., guest task assignment) for prompt action and completion based on one or more factors of the facility resource via a content processing system 192. For example, an attendant device proximate to the guest room, may be analyzed to determine the workload of the attendant, the distance of the attendant from the guest room, and typical response times of the attendant.

In certain embodiments, the content analysis system 191 may be configured to analyze each data block of each guest message to determine a task, request, communication, personnel, staff, order, service request, and the like, as described herein, using, for example, one or more machine learning (ML) models and/or artificial intelligence (AI) models. For example, one or more Generative AI models may be used to determine a guest request for transportation, location, time, destination, and so forth. In certain embodiments, a convolutional neural network may be implemented to determine one or more objects displayed or emphasized in one or more data blocks of an image, video, or visual content of the guest communication/message/request. Moreover, a convolutional neural network may be implemented to determine an offered/available service, event, location or destination, transportation option, restaurant, menu item, etc.

In some embodiments, the content analysis system 191 may configure a guest ticket to include details of the determined one or more departments, one or more tasks that can be completed by each department of the determined one or more departments, and a list of attendant devices assigned to each of the determined one or more departments. The content analysis system 191 and/or content processing system 192 may configure an assigned ticket as pending task approval whereby an approval by a manager device belonging to a manager (or senor staff/attendant) of a department of the establishment is required prior to communicating to one or more attendant devices the request for completion of the task. In one embodiment, the content analysis system 191 may request, based on an output of the machine learning model, additional data from the guest by the AI Chatbot system 190 for determining the one or more departments for handling the guest message. Further, the content analysis system 191 may communicate the generated ticket to all departments of the establishment to prioritize the guest. In certain embodiments, where the guest requests to talk to a manager, the content analysis system 191 and/or AI Chabot system 190 may directly notify managers of one or more (or all) departments through a notification on one or more manager devices with details and requests raised by the guest from the concerned room number allowing one or more managers to directly chat in real-time with the guest for their concern.

In one embodiment, the content processing system 192 may be configured to include an iterative algorithm to automate hospitality management by automatically assigning, delegating, and prioritizing tasks to various personnel or departments based on data from the facility database 150 and various factors to ensure prompt completion of a guest task. In one embodiment, the iterative algorithm may assign the generated ticket to one or more attendant devices for task completion. The iterative algorithm may further communicate a request from the one or more attendant devices a task completion status at regular intervals or periodically to notify the guest of the status of their request/task. The attendant device may also be configured to communicate with the guest device, if needed or as desired, to communicate the status of the task.

In certain embodiments, the iterative algorithm of the content processing system 192 may be configured to auto-assign the ticket to one or more attendant devices for task completion based on information from the facility database 150 bypassing staff member or manager approval, wherein the iterative algorithm auto-assigns the ticket based on at least one of: an availability, the department concerned, a pre-executed task, and the time complexity for the one or more staff members, corresponding to the one or more attendant devices, to complete the task. As an example, the guest may request a particular food item through the AI chatbot system 190 from a pool side bar/restaurant at the establishment. The content processing system 192 may determine the geographic location of the guest device, the nearest bar/restaurant offering the food item, and a nearby attendant device (staff member) to deliver the food item upon a guest placing an order for the food item. The AI chatbot system 190 may take the order and process a payment method for the guest then assign the guest task to the nearby staff or attendant device to complete the task. Moreover, the iterative algorithm of the content processing system 192 may determine a current workload (e.g., number of guest tasks assigned) of one or more proximate staff members to assign a guest task to an attendant having fewer guest tasks assigned that can timely complete the generated ticket and task.

In one embodiment, the iterative algorithm of the content processing system 192 may be configured to determine active attendant devices for assignment of the generated ticket and task to complete the task. As an example, attendant devices may be switched to inactive during breaks, lunch, or other engagements. In some embodiments, attendant devices may be switched to inactive or busy based excess current workload or inaccessible/distant proximity to the establishment. Further, the iterative algorithm may verify whether active attendant devices are present and nearby and whether one or more active attendant devices has the least or lowest number of assigned tasks. Moreover, the iterative algorithm may assign the generated guest ticket/task to the attendant with the lowest number of assigned tasks, closest proximity, active status, or any combination thereof. The iterative algorithm may store and update the details of a generated guest ticket/task in the guest data 155 (e.g., customer database) and send a notification to the active attendant device associated with the assigned task.

In one embodiment, the iterative algorithm of the content processing system 192 may be configured to close the ticket upon completion of the guest task associated with the guest ticket, further disable edits and updates to the ticket, and store the guest message, chat session, and a corresponding ticket data including images and time of creation, completion, status changes, ticket changes, task changes, and all ticket flags in the guest data 155 (e.g., customer database). In some embodiments, the iterative algorithm of the content processing system 192 may require the attendant/manager to take a picture indicative of completion of a guest task (e.g., delivery of food, packages, room items, etc.,), the picture may be subject to image verification using one or more ML/AI models (e.g., convolutional neural network), software, functions, or algorithms to verify completion of the task and enable the attendant to mark the task as completed on their attendant device prior to closing the guest ticket. The iterative algorithm of the content processing system 192 may implement one or more machine learning algorithms to analyze the verification picture submitted by the attendant device and match the verification picture details with the ticket details prior to closing the ticket.

In one embodiment, the automated management system 185, the content analysis system 191, and/or the content processing system 192 may include any number of microprocessors, microcontrollers, graphics processing units (GPUs), central processing units (CPUs), artificial intelligence processing units (AI PUs), neural processing units (NPUs), tensor processing units (TPUs), analog circuitry, or the like that may be programmed to execute computer-executable instructions for implementing aspects of this disclosure.

### Network Embodiment

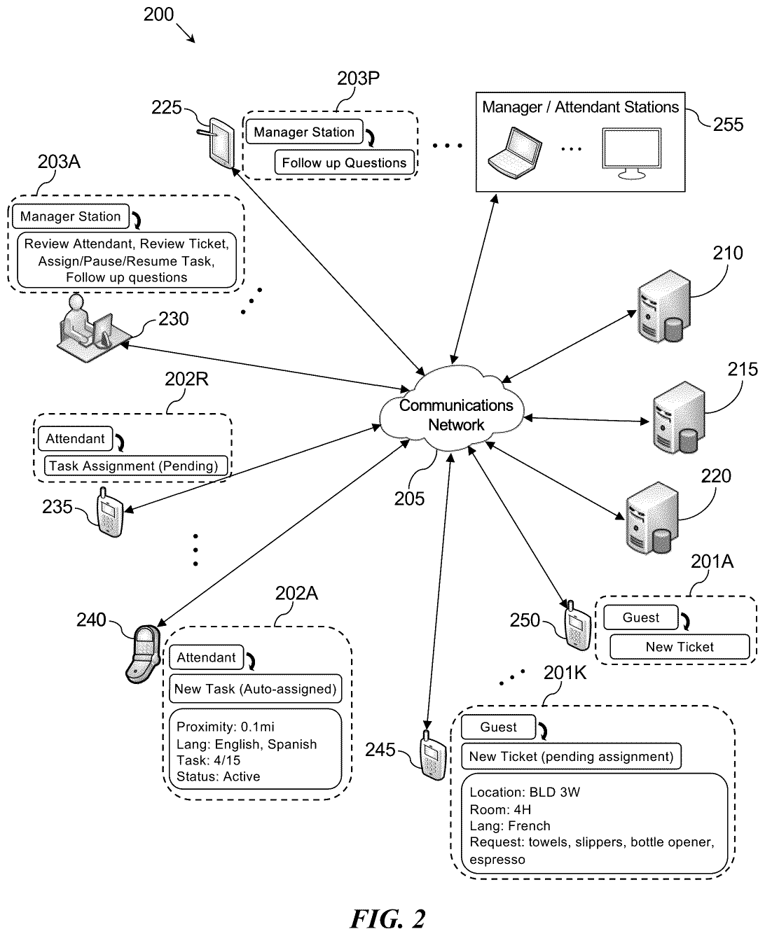

With reference to FIG. 2, one embodiment of a network environment 200 is illustrated that is configured with one or more computing devices 210, 215, and 220 each implementing one or more aspects of the AI driven hospitality services and management system 100 of FIG. 1 for automating and streamlining hospitality services and management. FIG. 2 illustrates a network environment 200 for a small, large, or very large-scale establishment, from one to several thousand rooms, indoor and outdoor services, amenities, and facilities, one to several hundred departments, and one to several thousand personnel, staff, services workers, and managers.

In many embodiments, the one or more computing devices 210, 215, 220 may comprise of one or more servers that connect one, several, or many user devices 225, 230, 235, 240, 245, 250, and/or a group of user devices 255 sequentially, in parallel, concurrently, or simultaneously to the AI driven hospitality services and management system 100 through one or more communications networks 205 to create, process, analyze, modify, view, delegate, assign, verify, complete, and store guest tickets and tasks. Each guest device 245, 250 . . . etc., may include one or more tickets 201A . . . 201K . . . etc., respectively, each ticket 201A . . . 201K . . . etc., having one or more guest tasks as determined by the AI Chatbot system 190 and/or the automated management system 185. Each generated guest ticket 201A . . . 201K . . . etc., may be configured by the AI Chatbot system 190 and/or the automated management system 185 to include a status, guest information, and request. Each attendant device 235, 240 . . . etc., may include one or more guest tasks 202A . . . 202R . . . etc., respectively, each task 202A . . . 202R . . . etc., corresponding to a guest ticket and including one or more requests, orders, or tasks assigned to the attendant device for completion. Moreover, the guest task may be updated in real-time with proximity information for the attendant, and the attendant information may be analyzed by the automated management system 185 in assigning the guest ticket/task to one or more attendant devices.

In one embodiment, each computing device 210, 215, 220 may be configured to implement the AI driven hospitality services and management system 100 and each computing device 210, 215, 220 may connect to, or otherwise form, a local area network. Each local network may include, but not be limited to, a computer network that covers a limited geographic area (e.g., a predetermined proximate geographic location), and is configured to include, for example, a local CDN network, a P2P network, a local area network (LAN), a local or hyperlocal distributed computing network, or any combination thereof. Further, each local network may include, but is not limited to, any of the following network topologies, including a bus network, a star network, a ring network, a mesh network, a star-bus network, tree or hierarchical network, and the like.

Each user device 225, 230, 235, 240, 245, 250, and/or a group of user devices 255, may represent various forms of processing devices. By way of illustration only and not by way of limitation, processing devices may include a mobile device, a desktop computer, a laptop computer, a handheld computer, a personal digital assistant (PDA), a cellular telephone, a network appliance, an Internet of Things (IoT) device, a smart phone, a tablet, or any combination of these processing devices.

In many embodiments, the iterative algorithm of the content processing system 192 may automatically assign tasks to one or more attendant devices based on various factors including proximity ranges, workload, response time, spoken languages, gender, seniority, and other factors as is contemplated. A proximity range requirement may include an attendant device distance between 0.01 miles-0.50 miles, an attendant device on the same floor, an attendant device in the same building. A response time requirement may include a task response of between 1-5 minutes for exceptional response, a task response of between 6-10 minutes for good response, and response time of 11-15 minutes for acceptable response time, and 15+ minutes for unacceptable response time. Workload requirement may include a weighting of tasks to be completed per hour or due in an hour, for example, a light workload for an attendant device may be 1-5 tasks, a medium workload may be 6-10 tasks, and a heavy workload may be 11 or more tasks. The iterative algorithm of the content processing system 192 may prioritize guest tasks to light workload attendant devices thereby allowing attendants to service the guest while ensuring the attendant's workload is manageable at each hour. Further, the iterative algorithm of the content processing system 192 may implement a combination of the above factors to ensure guests response times are prompt and attendant workloads are manageable. In some embodiments, the iterative algorithm of the content processing system 192 may distribute one or more determined guest tasks from a guest ticket to one or more attendant devices based on the factors described herein to ensure prompt guest response times.

With reference again to FIG. 2, as an example, a guest ticket 201K may include location information: BLD 3W, room number: 4H, language requested: French, and specific guest requests of towels, slippers, bottle opener, and espresso. The guest ticket 201K associated with guest device 245 may be pending until a department manager delegates the guest ticket to an attendant device or the content processing system 192 auto-assigns the guest ticket to an attendant matching one or more requirements. The guest ticket 201K may be auto assigned by the iterative algorithm of the content processing system 192 to an attendant device if one or more requirements are met, for example, a proximity requirement (e.g., distance between 0.01 mi-0.02 mi, same floor, same building, etc.,), a language requirement (French), a department requirement (e.g., housekeeping). As another example, an attendant device 240 is auto-assigned guest task 202A based on close proximity, Spanish spoken language, and light workload of 4 tasks. As an example, the attendant device 240 may be configured to accept a maximum workload of 15 assignable tasks per hour. In certain embodiments, each manager may access one or more guest tickets/tasks 203A . . . 203P . . . etc., through a manager device 225, 230 . . . etc., then delegate guest tasks to attendant devices. In some embodiments, the manager device 225 may be used to contact the guest to assign the task to an attendant device. In certain embodiments, the guest may directly contact a manager device 225 or manager station 255, for example, a manager at the front desk, concierge, lobby, or facility/building.

### Method for AI Hospitality Services and Management

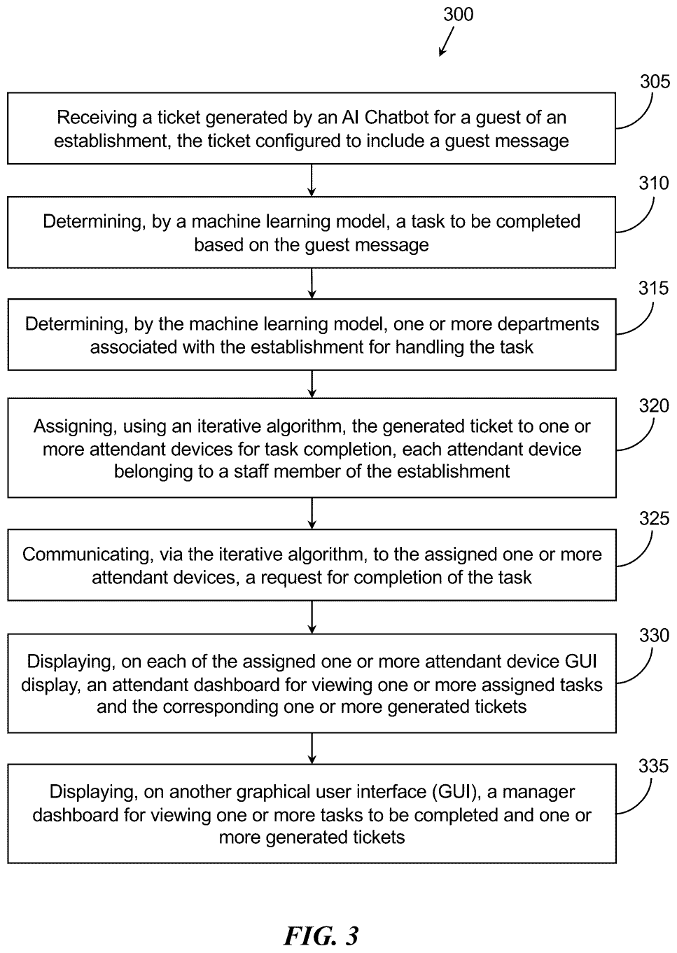

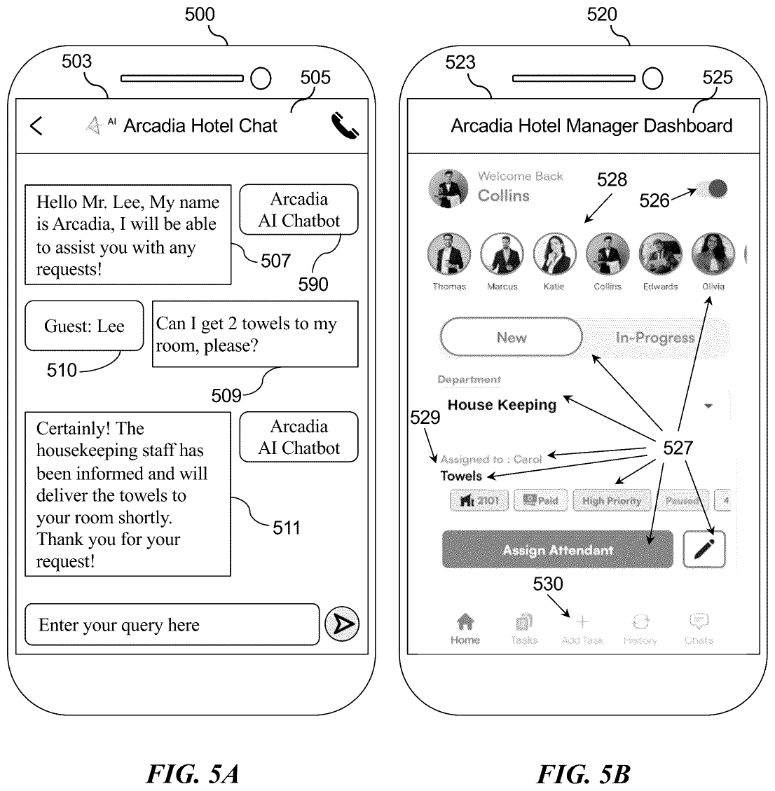

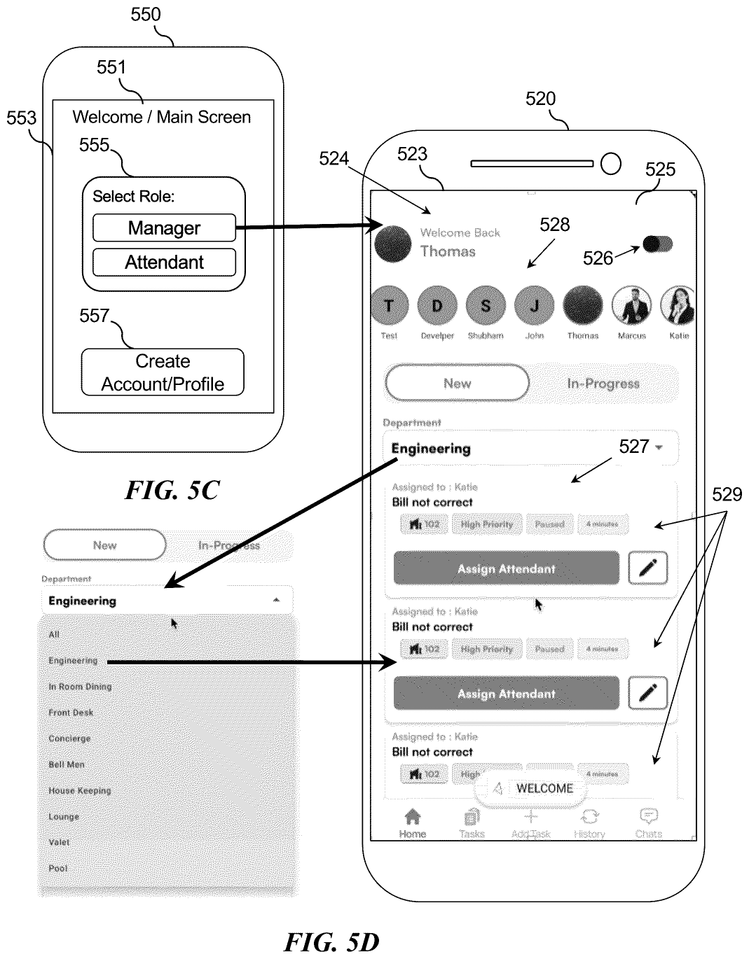

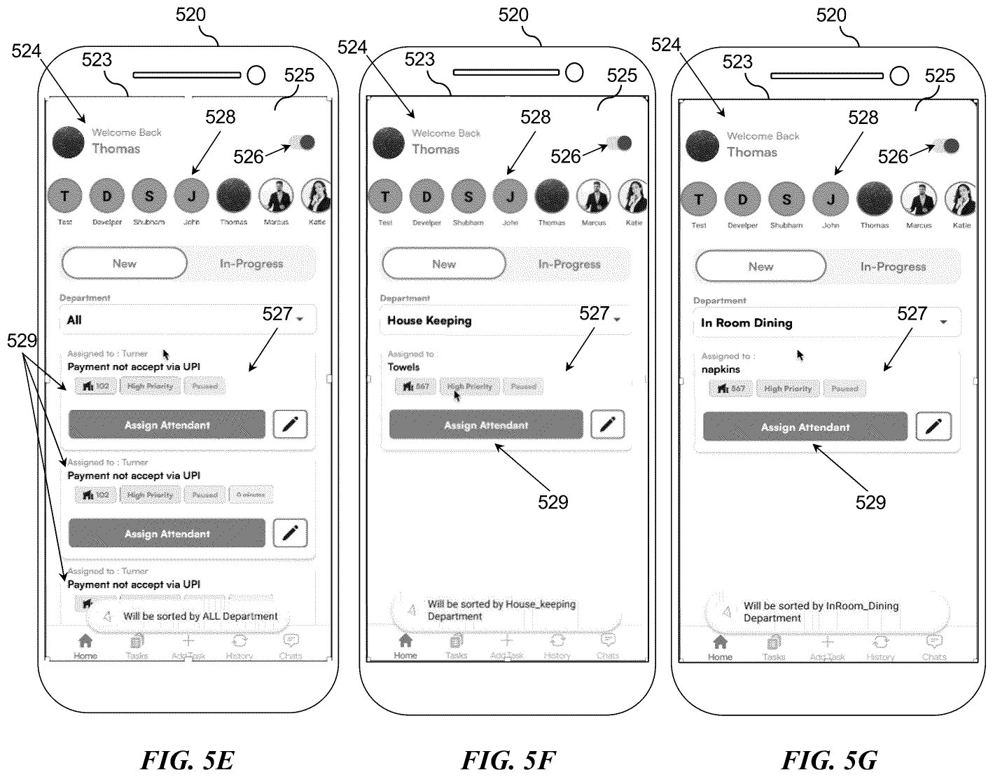

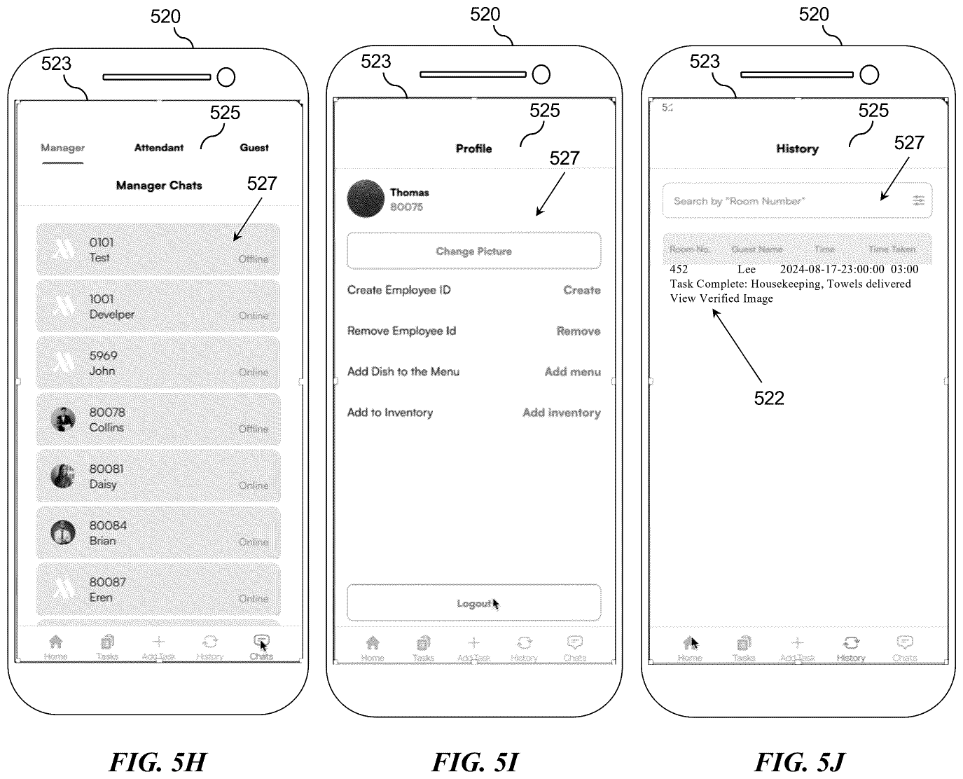

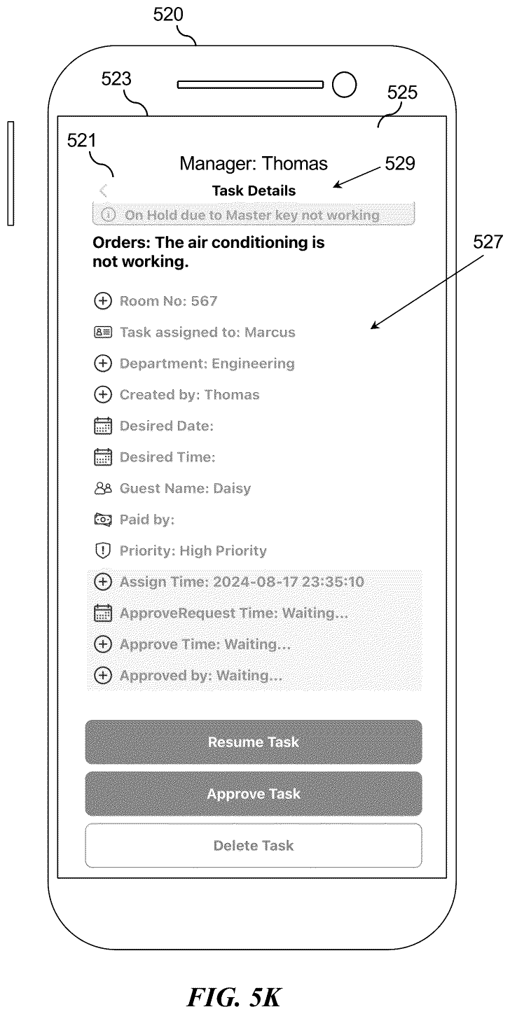

FIG. 3 illustrates one embodiment of a method performed by the AI driven hospitality services and management system of FIG. 1 for automating and streamlining hospitality services and management. The method may include various programs, algorithms, logic, applications, and systems for processing guest tickets and requests to determine one or more guest tasks, creating guest tasks, analyzing available resources at one or more establishments/facilities/buildings for handling each guest task, modifying guest tickets or tasks, viewing the status of a guest task/ticket, delegating or distributing guest tickets/tasks to personnel/staff, assigning (auto-assigning) guest tasks for review or action, monitoring and verifying completion of guest tasks, and storing guest tickets and tasks for analytics, insights, and predictive actions associated with actions and activities that take place within the AI driven hospitality services and management system. Each block shown in FIG. 3 may represent one or more processes, methods, or subroutines, carried out in the exemplary method. For explanatory purposes, method 300 will be described with reference to FIGS. 5A-5K, 6A-6C, 7A-7B, 8A-8B, and 9 which show example embodiments of carrying out the method of FIG. 3 for processing guest tickets and requests to determine one or more guest tasks, creating guest tasks, analyzing available resources at one or more establishments/facilities/buildings for handling each guest task, modifying guest tickets or tasks, viewing the status of a guest task/ticket, delegating or distributing guest tickets/tasks to personnel/staff, assigning (auto-assigning) guest tasks for review or action, monitoring and verifying completion of guest tasks, and storing guest tickets and tasks for analytics, insights, and predictive actions. The AI driven hospitality services and management system 100 may facilitate guest ticket and task creation, modification, task analysis and routing, and task allocation/delegation, management, and monitoring as described herein. Method 300 may be used independently or in combination with other methods or processes for facilitating processing of guest tickets and requests to determine one or more guest tasks, creating guest tasks, analyzing available resources at one or more establishments/facilities/buildings for handling each guest task, modifying guest tickets or tasks, viewing the status of a guest task/ticket, delegating or distributing guest tickets/tasks to personnel/staff, assigning (auto-assigning) guest tasks for review or action, monitoring and verifying completion of guest tasks, and storing guest tickets and tasks for analytics, insights, and predictive actions for an establishment, facility, or building having guests or tenants.

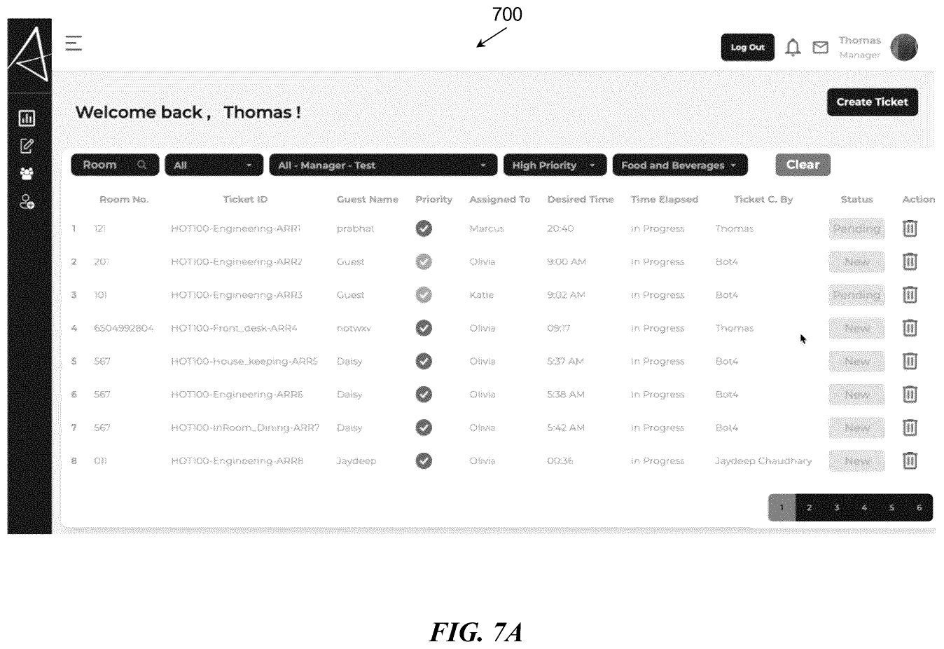

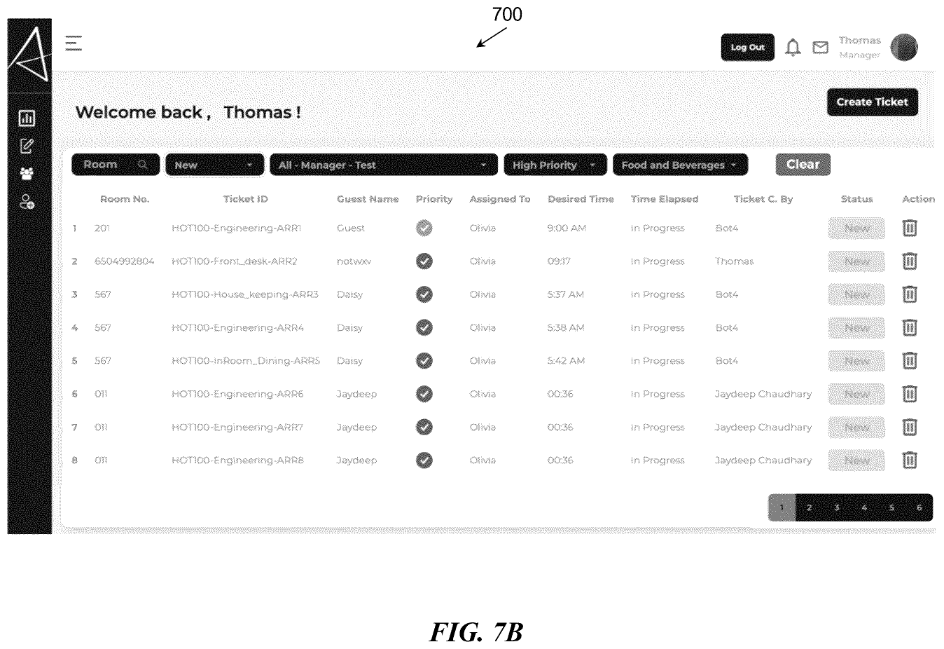

In one embodiment, the method 300 may be implemented and performed by the AI driven hospitality services and management system 100 of FIG. 1. With the AI driven hospitality services and management system 100, attendants, staff, and managers of an establishment, facility, or service provider may automatically and seamlessly receive relevant tasks and information that can be turned into an actionable task to service a guest or tenant of an establishment. The AI driven hospitality services and management system 100 may continuously access and verify information in real-time about an establishment and its staff as stored in a facility database 150 thereby making the task of managing, monitoring, and delegating multiple (potentially hundreds of) guest tasks manageable and efficient by determining the most capable and responsive set of resources for completing a guest task. The user interface shown in FIG. 5A may refer to a guest or tenant account, the user interface shown in FIGS. 5B, 5C, 5D-5K, and 7A-7B may refer to a manager or administrator account, the user interface shown in FIGS. 5C, 6A-6C, and 8A-8B refer to an attendant, staff, or personnel account, however the interface, navigation, content, and communication means and functions can be configured as needed such that both attendant and manager devices can view guest tickets and assigned guest tasks in real-time such that one or more attendants and managers can assist as needed in completing guest tasks.

Method 300 begins at block 305, the method includes receiving a ticket generated by an AI Chatbot for a guest of an establishment, the ticket configured to include a guest message. As one example, FIG. 5A illustrates a graphical user interface for displaying guest messages in a guest chat session, the guest messages having one or more data blocks that may include at least one of a guest request, feedback, comment, and tasks. FIG. 5A is described in more detail below.

For example, FIG. 5A shows one embodiment of a guest chat screen 503 in a graphical user interface (GUI) 505 for displaying a chat session between a guest 510 and an AI Chatbot system 590 on a guest device 500. The conversation includes a plurality of data blocks 507, 509, and 511. As an example, the guest response in data block 509 may be processed by the AI Chatbot system 590 to determine one or more tasks related to housekeeping. In some embodiments, as is contemplated, the AI Chatbot system 590 may ask follow-up questions to determine other guest tasks or other relevant information such as response time, priority, or in cases of verbal communication, tone or urgency in a guest's voice. In some embodiments, the AI Chatbot system 590 may initiate a direct connection with an attendant or manager in cases of emergency or may request an AI driven verbal two-call or dialog whereby the audio content of the verbal communication may be transcribed as a text file. For example, the AI Chatbot system 590 may request from the guest, “would you like me to give you a call so that you may discuss your request or issue with Arcadia AI? ” The AI Chatbot system 590 may communicate guest chat sessions to the content analysis system 191. In certain embodiments, the content analysis system 191 may store the guest message(s) as a voice memo, a text data file containing a transcription of the voice memo, and a text file containing one or more chat session in the facility database for storage 150.

With reference again to FIG. 3, at block 310, the method includes determining, by a machine learning model, a task to be completed based on the guest message (i.e., determining guest tasks from one or more data blocks of the chat session). At block 315, the method includes determining, by the machine learning model, one or more departments associated with the establishment for handling the task. The content analysis system 191 may process each data block from the guest messages and build a list of relevant facility resources from the facility database 150. The relevant facility resources may include appropriate personnel or department for handling each task. As one example, FIG. 5B illustrates a graphical user interface for displaying facility resources, in part, related to a selected department having guest tickets/requests, a listing of personnel for contact or task assignment, and options for view and modifying a guest task/ticket. FIG. 5B is described in more detail below.

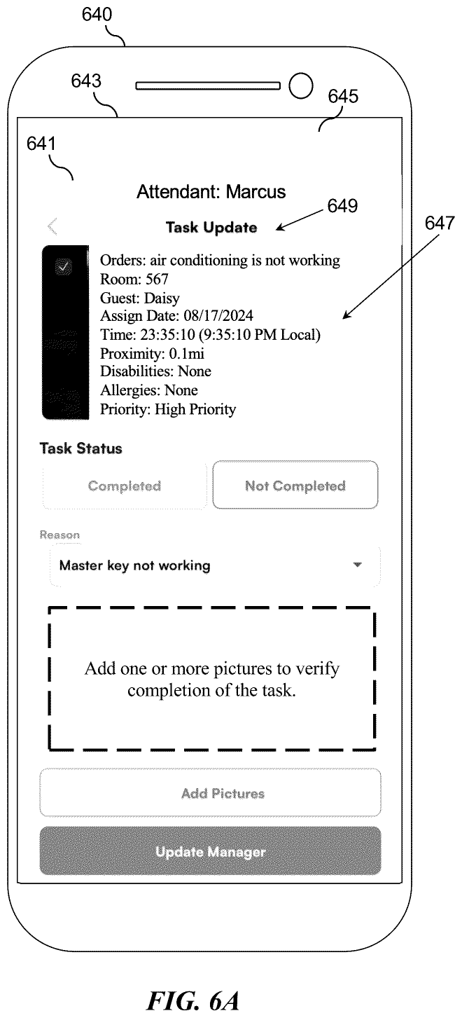

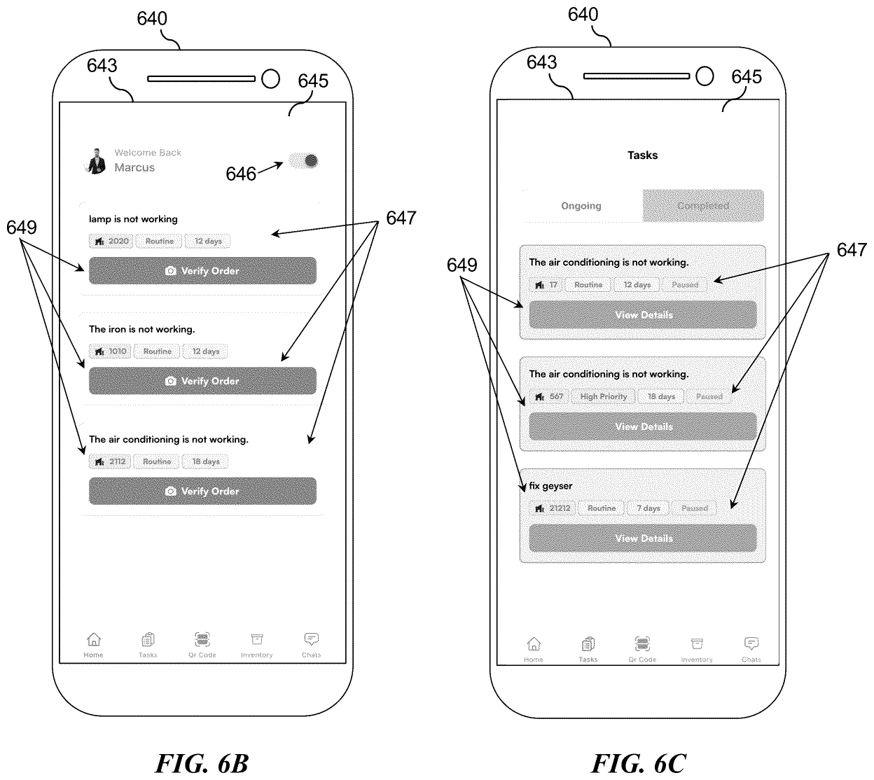

For example, FIG. 5B shows one embodiment of a manager screen 523 in a graphical user interface (GUI) 520 for displaying one or more facility data 527 from facility database 150, including a listing of attendants and managers, task status, departments, assigned guest ticket, guest tasks, guest information (e.g., payment, room, priority, task status, mobile/room phone number, etc.,), assignment option such as editing the assignment, pausing the task, or cancelling the task., or assig assigned attendants and managers, as an example. Further, the manager device 520 may be used to create guest tasks 530 that is handled by the AI hospitality services and management device as a guest ticket. Managers may create guest tasks in response to a guest request, communication, or call. Moreover, the manager may toggle their status 526 to online or offline updating the facility database with their availability to handle guest tasks. With reference to FIGS. 5E-5G, for every department, each guest task 529 may be viewed, modified, or assigned to a manager or attendant device. A manager may select from a list of personnel 518 (i.e., attendants or managers) to assign or transfer a guest task 529 based on facility data 527 collected and displayed for each guest task 529. The manager may access the guest task 529 to obtain guest ticket information as shown in FIGS. 5K and 6A, for example.

With reference again to FIG. 3, at block 320, the method includes assigning, using an iterative algorithm, the generated ticket to one or more attendant devices for task completion, each attendant device belonging to a staff member of the establishment. At block 325, the method includes communicating, via the iterative algorithm, to the assigned one or more attendant devices, a request for completion of the task. As one example, FIG. 5K illustrates a graphical user interface for displaying a guest ticket 521 assigned to an attendant on a manger device 520, and FIG. 6A illustrates a graphical user interface for displaying a guest ticket 641 assigned as a guest task 649 on an attendant device 640. FIGS. 5K and 6A are described in more detail below.

With reference to FIGS. 5A, 5K, and 6A as another guest request example, the guest response in data block 509 may instead relay information such a repair service order or issue with a guest room such as repairing an air conditioning unit. A guest task 529 created from data block 590 is shown in on a manager device 520 in FIG. 5K and a guest task assigned 649 to an attendant device 640 is shown in FIG. 6A. As shown in FIG. 5K, facility data 527 related to the guest request may include a service order for repairing the air conditioning unit, the room number, task assignment, department, creation time and date, guest name, payment made, priority, and approval and assignment information. Whether the guest task is auto assigned or assigned manual, the manager device 520 may be configured to allow managers to resume, approve or cancel tasks in case there are issues with completing the service order, for example, when the master key or access to the room is not available.

FIG. 6A show one embodiment of an attendant screen 643 in a graphical user interface (GUI) 640 for displaying a guest ticket 641 containing a guest task 649 and facility data 647 (relevant facility resources) from facility database 150, including a listing of attendants and managers, task status, departments, assigned guest ticket, guest tasks, guest information (e.g., payment, room, priority, task status, mobile/room phone number, etc.,), assignment option such as editing the assignment, pausing the task, or cancelling the task., or assig assigned attendants and managers, as an example. Upon completion of the guest task 649, the attendant may use the attendant device 640 to take a picture to show the task has been completed.

With reference again to FIG. 3, at block 330, the method includes displaying, on each of the assigned one or more attendant device GUI display, an attendant dashboard for viewing one or more assigned tasks and the corresponding one or more generated tickets. FIGS. 6B-6C show one embodiment of an attendant screen 643 in a graphical user interface (GUI) 640 for displaying a list of guest tasks 640 containing facility data 647 (relevant facility resources) from facility database 150. The attendant may have an option to select to complete an assigned task, update the status or progress of the assigned task, or request a manager approval for completing the assigned task corresponding to the generated ticket. Moreover, based on the attendant status 646 of the attendant device, the AI hospitality service and management system 100, a manager device 520, or a combination thereof may assign one or more guest tasks 649 to the attendant device 640. For example, a manager may see the attendant online in the personnel listing 528, and in response to determining the attendant device to have an active status, configuring the task to be approved and completable by the attendant. Similarly, the AI hospitality service and management system 100 may, in response to determining the active status of the attendant device, automatically assign one or more guest tasks 649 to an active status attendant device. The attendant device will request the attendant to provide image verification or facial recognition of the attendant to determine the active status of the attendant and to mark the task as completed.

Further, the attendant device may display all details of a guest ticket including the ticket progress upon determining the attendant device to have an active status. As shown in FIG. 5J, upon completion of a guest ticket 522, the completed ticket 522 will not accept any further changes. The completed ticket 522 and corresponding tasks may be moved to a history section of the attendant device and communicated to a manager or administrator account on a manager device 520 whereby the user can view the completed task.

With reference again to FIG. 3, at block 335, the method includes displaying, on another graphical user interface (GUI), a manager dashboard for viewing one or more tasks to be completed and one or more generated tickets. With reference to FIGS. 5C-5D, one embodiment of a user login screen 551 in a graphical user interface (GUI) 553 for displaying one or more login roles 555 and creating an account 557 on a user device 550 is shown. As shown in FIG. 5D, a manager may login to access a manager dashboard 524. The manager dashboard 524 may include a listing and access to all departments of an establishment, facility data 527 related to a listing of all guest tasks 529, manager active status 526, and a listing of available/assignable personal 528, and other facility data 527 relevant to each guest task and ticket. With reference to FIGS. 5H-5J, a manager account (or administrative or IT account) may be configured by an establishment to manually access facility data 527, such as guest chat sessions, manager chats, user profile, completed tasks 522, and attendant chats to review response times and obtain insights on best practices or procedures for guest communication as well as to view manager/attendant guest task assignments made by the AI driven hospitality services and management system 100.

### Run-Time or Operational Method

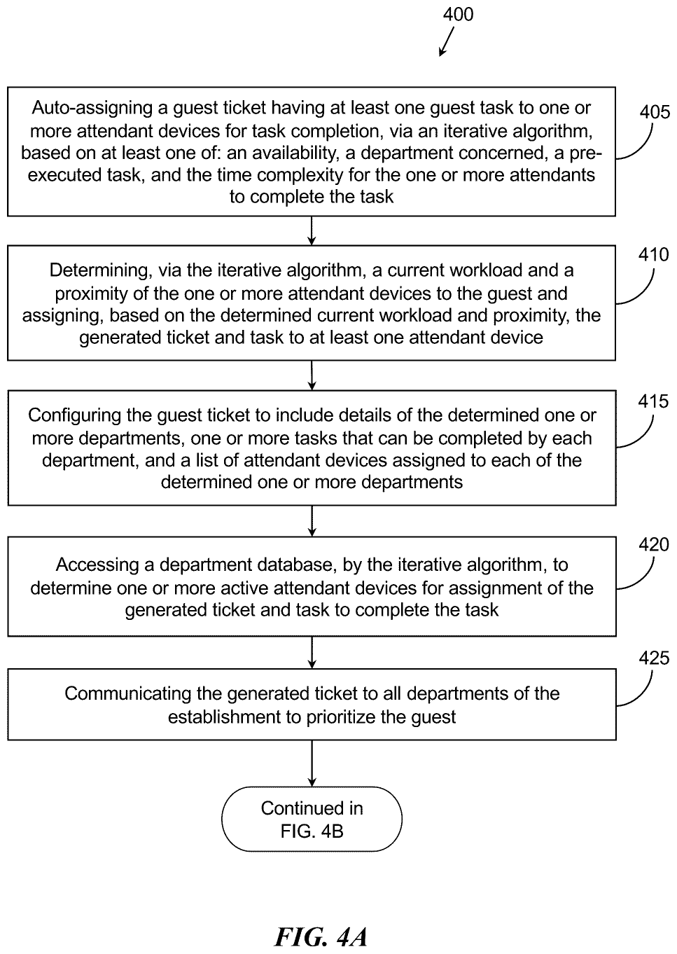

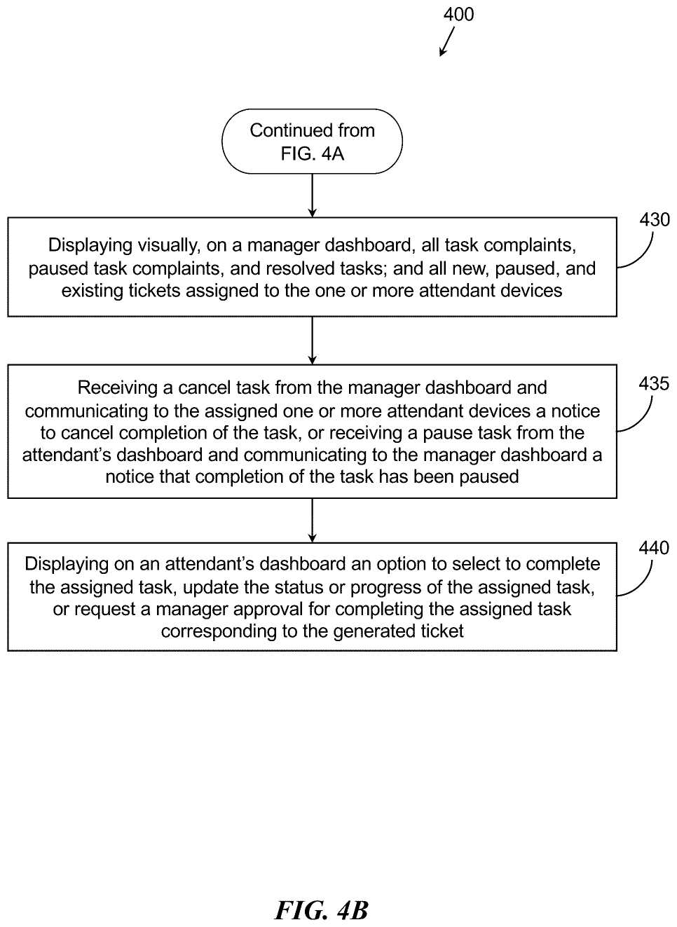

FIGS. 4A-4B illustrate one embodiment of an overview of a run-time or operational method associated with the system of FIG. 1 for operations, communications, and transactions made within the AI driven hospitality services and management system of FIG. 1. The method may include various programs, algorithms, logic, applications, and systems for processing guest tickets/requests to determine one or more departments and/or personnel for guest ticket and task assignment, accessing a facility database having additional information for assigning the guest ticket and distributing guest tasks from the guest ticket, configuring the guest ticket to include the additional information from the facility database based one or more guest conversations or messages, assigning guest tasks and the guest ticket to one or more personnel/departments, and displaying and receiving task status or task modifications from one or more personnel devices associated with an establishment or hospitality service provider. Each block shown in FIG. 4 may represent one or more processes, methods, or subroutines, carried out in the exemplary method. For explanatory purposes, method 400 will be described with reference to FIGS. 1, 2, 5K, 6A-6C, 7A-7B, and 9, which show example embodiments of carrying out the method of FIG. 4 for processing guest tickets/requests to determine one or more departments and/or personnel for guest ticket and task assignment, accessing a facility database having additional information for assigning the guest ticket and distributing guest tasks from the guest ticket, configuring the guest ticket to include the additional information from the facility database based one or more guest conversations or messages, assigning guest tasks and the guest ticket to one or more personnel/departments, and displaying and receiving task status or task modifications from one or more personnel devices associated with an establishment or hospitality service provider. Method 400 may be used independently or in combination with other methods or processes for processing guest tickets/requests to determine one or more departments and/or personnel for guest ticket and task assignment, accessing a facility database having additional information for assigning the guest ticket and distributing guest tasks from the guest ticket, configuring the guest ticket to include the additional information from the facility database based one or more guest conversations or messages, assigning guest tasks and the guest ticket to one or more personnel/departments, and displaying and receiving task status or task modifications from one or more personnel devices associated with an establishment or hospitality service provider. Method 400 may be performed by the facility management application 120 of the client computing device 105, the automated management system 185, or both.

Method 400 begins at block 405, the method includes auto-assigning a guest ticket having at least one guest task to one or more attendant devices for task completion, via an iterative algorithm, based on at least one of: an availability, a department concerned, a pre-executed task, and the time complexity for the one or more attendants to complete the task.

In block 410, the method includes determining, via the iterative algorithm, a current workload and a proximity of the one or more attendant devices to the guest and assigning, based on the determined current workload and proximity, the generated ticket and task to at least one attendant device.

In block 415, the method includes configuring the guest ticket to include details of the determined one or more departments, one or more tasks that can be completed by each department, and a list of attendant devices assigned to each of the determined one or more departments.

In block 420, the method includes accessing a department database, by the iterative algorithm, to determine one or more active attendant devices for assignment of the generated ticket and task to complete the task.

In block 425, the method includes communicating the generated ticket to all departments of the establishment to prioritize the guest.

In block 430, the method includes displaying visually, on a manager dashboard, all task complaints, paused task complaints, and resolved tasks; and all new, paused, and existing tickets assigned to the one or more attendant devices.

In block 435, the method includes receiving a cancel task from the manager dashboard and communicating to the assigned one or more attendant devices a notice to cancel completion of the task or receiving a pause task from the attendant's dashboard and communicating to the manager dashboard a notice that completion of the task has been paused.

In block 440, the method includes displaying on an attendant's dashboard an option to select to complete the assigned task, update the status or progress of the assigned task, or request a manager approval for completing the assigned task corresponding to the generated ticket.

### In-Place Ticket Access and Management Embodiment

Referring to FIGS. 7A-7B, is one embodiment of a schematic illustration of all pending and new tickets for guests at an establishment displayed in a graphical user interface (GUI) of a manager's device or login within the AI driven hospitality services and management system associated with FIG. 1. As shown in the manager dashboard 700, each manager device may access guest tickets assigned to their department and view each stage of a guest ticket processing. In some embodiments, any authorized user or personnel device (e.g., a senior staff or attendant) may be configured to access a manager dashboard. The manager dashboard 700 may list room information, ticket IDs (ticket information), guest name (guest information), priority, attendant assignment, desired time (estimated time for completion), elapsed time, source of ticket creation (AI system “Bot4”, or named personnel), status of guest ticket, and ticket action (e.g., delete or pause). The AI driven hospitality services and management system 100 may modify guests'tickets by amending to each guest ticket a list of one or more tasks, departments, personnel, and other information for a handler or manager to view and verify such that each guest ticket or task may be manually or visually verified at each stage of processing and handling. The guest ticket may undergo through various manually confirmable stages, for example. A first stage may include task verified status meaning the tasks are verified and a task list is added to the guest ticket. A second stage may include department verified status meaning the guest ticket and tasks have been processed and the appropriate personnel group, manager group, or departments are assigned to the guest ticket. A third stage may include personnel or manager assigned status meaning the guest ticket and tasks have been assigned to an appropriate handler (e.g., attendant device or manager device) for task completion. It is contemplated that a guest ticket may include one or more tasks that may need to be routed to different departments. In such cases, the assigned personnel, department, task may be displayed prominently based on the user device accessing the guest ticket to avoid confusion or unclarity. Moreover, to maintain privacy or integrity of communications the guest tickets may be accessible by only assigned or relevant personnel, departments, or managers provide access authorization by the establishment.

With reference to FIGS. 7A-7B, a manager device may include a graphical user interface for displaying a manager dashboard 700. In one embodiment, the manager dashboard may display all task complaints, give the user the option to pause tasks, or pause tasks that have complaints, and resolve tasks. As shown in FIG. 7B, all new tasks may be paused and existing tickets may be assigned to the one or more attendant devices through the manager dashboard. Further, the manager dashboard 700 may provide the user with options for editing tickets, reassigning a new ticket to one or more different attendant devices, and resuming a ticket in progress to one or more different attendant devices. In certain embodiments, the manager dashboard 700 may display a real-time view of the tickets and the tasks added and updated, the guest message and one or more chat sessions between the AI Chatbot and the guest that generated the ticket. In one embodiment, the manager dashboard 700 may display a progress on the task and a list of actions for managing the task, the list of actions including: view status of task, view issue with task, abort task, resume task, pause task, and reschedule task; wherein selecting the ticket will display all the details and changes of the ticket. Moreover, the manager dashboard 700 may display at least one of the following associated with the ticket: one or more chat sessions between a manager and a staff member and one or more chat sessions between staff members. Further, the manager dashboard 700 may allow a user to communicate a cancel task order to the assigned one or more attendant devices assigned a guest ticket. The attendant device may receive a notice to cancel completion of the task. In many embodiments, the attendant device may be configured to communicate a pause task to the manager device and manager dashboard 700 indicating an issue, concern, or otherwise inability to complete a guest task from a guest ticket, and a notice that completion of the task has been paused may be displayed on the attendant device and the manager dashboard 700. Moreover, the status of a guest ticket or task may be updated with a pause case flag and a reason for pausing or cancelling completion of the task.

### Hospitality Service/Product Listing Embodiment

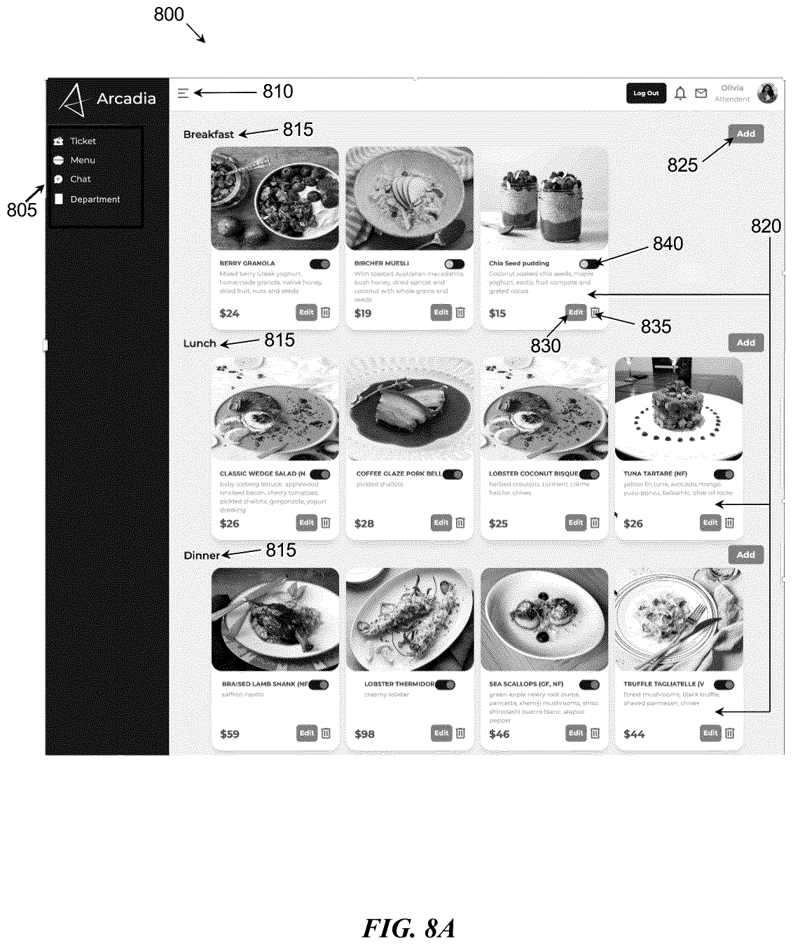

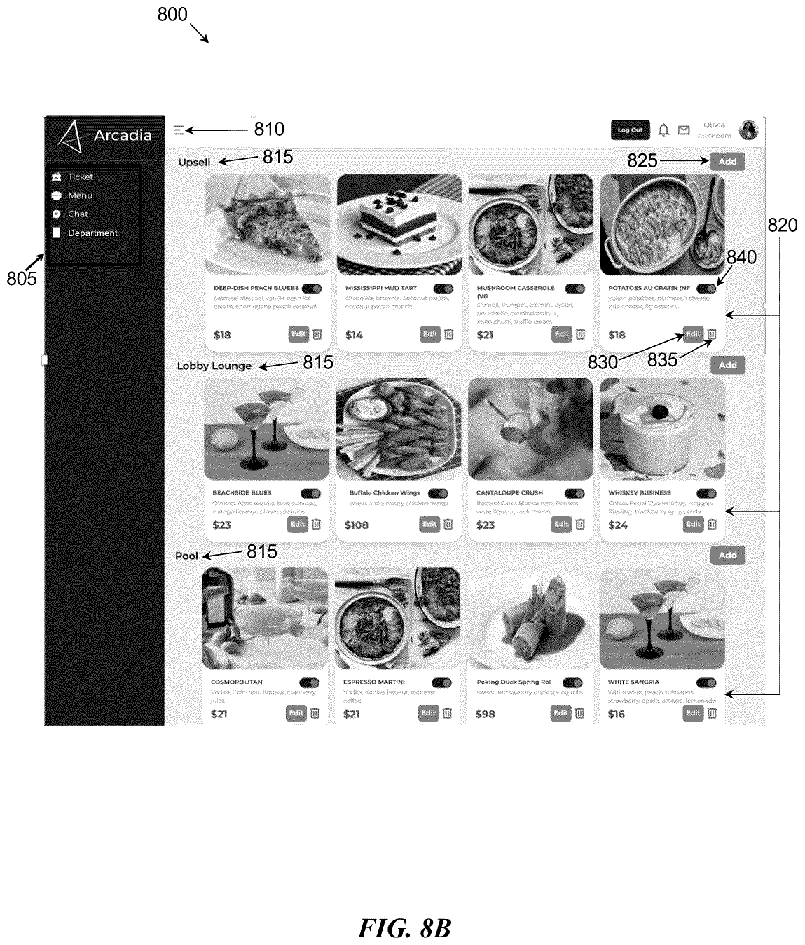

FIGS. 8A-8B is one embodiment of a schematic illustration of example services and menus for guests at an establishment displayed in a graphical user interface (GUI) of a manager's device or login within the AI driven hospitality services and management system associated with FIG. 1. As shown, an attendant device may include a graphical user interface for displaying an attendant dashboard 800, each attendant device may be provided with access to configure, add, edit, or otherwise manage services and products offered for their department/facility/building. The inputted information is stored in the facility database 150 for the particular department/facility, for example, dining department or a selected restaurant from a list of departments. In some embodiments, an authorized user or personnel device (e.g., a senior staff or manager) may be configured to access an attendant dashboard. The attendant dashboard 800 may access facility data through an attendant service menu 805, the service menu 805 may list department guest tickets, guest messages/chats, and menu items, and one or more departments assigned/accessible to the attendant device. The attendant dashboard 800 may include a settings menu 810 where attendants can view their rank, response times, language, status, task lists, location and personal information as is contemplated and described herein that may be used by the AI hospitality services and management system for determining/assigning guest tasks/tickets. Further, the attendant dashboard 800 may be configured to display, per meal/good/service item 815, a list of related services/goods 820 offered. One or more goods/services 820 may be added by the attendant through add good/services 825. The price, description, and details of each good/service 820 may be edited 830, deleted 835, or may unavailable 840. As shown in FIGS. 8A-8B, some example departments, services, and facilities are list such as a breakfast, lunch and dinner menu from, for example, an indoor, outdoor, or proximate restaurant associated with the establishment. Moreover, other example departments may include establishment or guest services such as pool side service and products, food or catering options. The AI hospitality services and management system 100 may delegate or assign tickets to the attendant, an establishment may further configure the attendant device and attendant dashboard to visually inspect a listing of services, products, departments, amenities, and the like, as shown in FIGS. 8A-8B, for example. In some embodiments, the attendant may manually view and complete assigned tasks through the attendant dashboard while also having control to edit or modify available services, products, departments, amenities, and the like. For example, the attendant may edit product/service listings as discontinued, unavailable for the day, out of order, under construction, closed, etc., and send the task to a manager for review to pause or cancel the task or request. Further, the iterative algorithm may analyze the updated task or guest ticket based on the attendant/manager input and update the facility database 150 with relevant information for a service, product, department, amenity, etc.

### Definitions

A “establishment”, “building”, “facility”, “resort”, “hotel”, “home”, “apartment”, “condominium”, or “property” as used herein includes, but is not limited to, any one or more facilities or buildings that provide services such as hospitality services to one or more guests, tenants, or residents of the facility or building.

A “guest”, “tourist”, “visitor”, “resident”, “member”, or “tenant” as used herein includes, but is not limited to, any individual staying, purchasing, or otherwise using services or products provided by a building, facility, establishment, or product or service provider.

A “client device”, “remote client device”, “guest device”, “external computing device”, “guest computing device”, “attendant device”, “personnel device”, “staff device”, or “manager device” as used herein includes, but is not limited to, any computing device capable of running, view, or accessing, the automated management system, including software, code, functions, algorithms, or instructions associated therein, as well as access a facility/building database as needed or as authorized.

A “guest message”, “guest request”, “guest ticket”, “ticket”, “task”, “message”, or “request” as used herein includes, but is not limited to, any data containing, referenced to, or associated with a guest request, chat session, conversation, message, correspondence, communication, guest setting, or guest preference originating from or associated with a guest and/or a guest computing device.

Some examples may include, order for a service/product, inquiry, request, review, feedback, complaint, help/assistance, task cancel/abort, do not disturb.

### Computing Device Embodiment

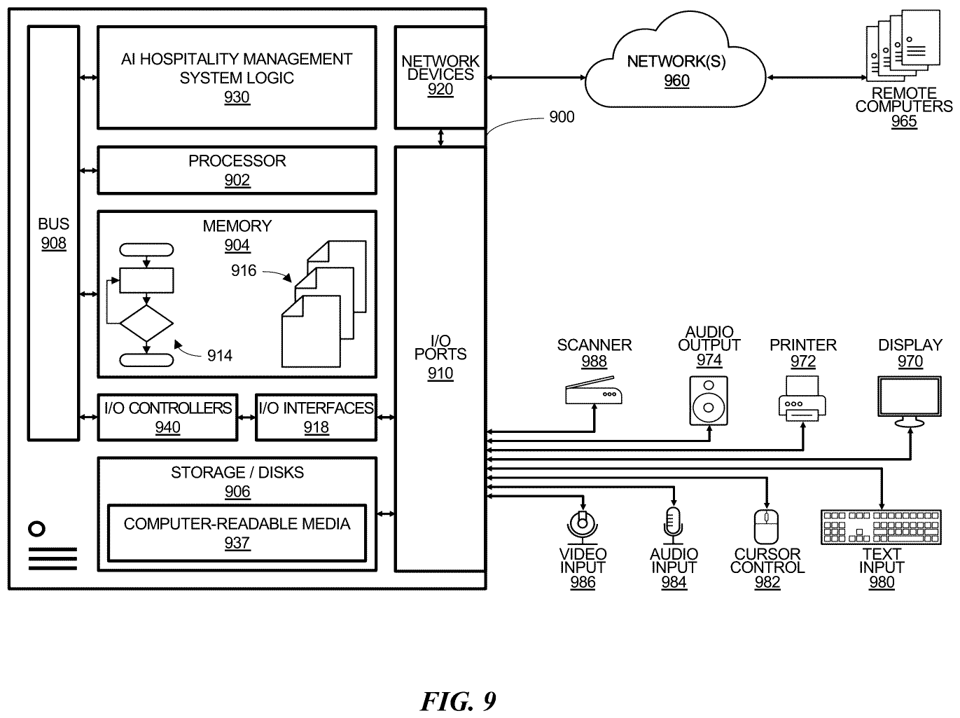

FIG. 9 illustrates an example computing device that is configured and/or programmed as a special purpose computing device with one or more of the example systems and methods described herein, and/or equivalents. The example computing device may be a computer 900 that includes at least one hardware processor 902, a memory 904, and input/output ports 910 operably connected by a bus 908. In one example, the computer 900 may include AI hospitality management system logic 930 configured to facilitate processing of guest tickets and requests to determine one or more guest tasks, creating guest tasks, analyzing available resources at one or more establishments/facilities/buildings for handling each guest task, modifying guest tickets or tasks, viewing the status of a guest task/ticket, delegating or distributing guest tickets/tasks to personnel/staff, assigning (auto-assigning) guest tasks for review or action, monitoring and verifying completion of guest tasks, and storing guest tickets and tasks for analytics, insights, and predictive actions for an establishment, facility, or building having guests or tenants as the automated navigation system 100 and associated figures. The AI hospitality management system logic 930 generates, distributes, assigns, and manages guest tickets and guest tasks as described herein. In different examples, the logic 930 may be implemented in hardware, a non-transitory computer-readable medium 937 with stored instructions, firmware, and/or combinations thereof. While the logic 930 is illustrated as a hardware component attached to the bus 908, it is to be appreciated that in other embodiments, the logic 930 could be implemented in the processor 902, stored in memory 904, or stored in disk 906.

In one embodiment, logic 930 or the computer is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an ASIC programmed to facilitate serial or parallel execution of processing of guest tickets and requests to determine one or more guest tasks, creating guest tasks, analyzing available resources at one or more establishments/facilities/buildings for handling each guest task, modifying guest tickets or tasks, viewing the status of a guest task/ticket, delegating or distributing guest tickets/tasks to personnel/staff, assigning (auto-assigning) guest tasks for review or action, monitoring and verifying completion of guest tasks, and storing guest tickets and tasks for analytics, insights, and predictive actions for an establishment, facility, or building having guests or tenants. The means may also be implemented as stored computer executable instructions that are presented to computer 900 as data 916 that are temporarily stored in memory 904 and then executed by processor 902.

Logic 930 may also provide means (e.g., hardware, non-transitory computer-readable medium that stores executable instructions, firmware) for performing one or more of the disclosed functions and/or combinations of the functions.

Generally describing an example configuration of the computer 900, the processor 902 may be a variety of various processors including dual microprocessor and other multi-processor architectures. A memory 904 may include volatile memory and/or non-volatile memory. Non-volatile memory may include, for example, ROM, PROM, and so on. Volatile memory may include, for example, RAM, SRAM, DRAM, and so on.

A storage disk 906 may be operably connected to the computer 900 via, for example, an input/output (I/O) interface (e.g., card, device) 918 and an input/output port 910 that are controlled by at least an input/output (I/O) controller 940. The disk 906 may be, for example, a magnetic disk drive, a solid-state disk drive, a floppy disk drive, a tape drive, a Zip drive, a flash memory card, a memory stick, and so on. Furthermore, the disk 906 may be a CD-ROM drive, a CD-R drive, a CD-RW drive, a DVD ROM, and so on. The memory 904 can store a process 914 and/or a data 916, for example. The disk 906 and/or the memory 904 can store an operating system that controls and allocates resources of the computer 900.

The computer 900 may interact with, control, and/or be controlled by input/output (I/O) devices via the input/output (I/O) controller 940, the I/O interfaces 918, and the input/output ports 910. Input/output devices may include, for example, one or more displays 970, printers 972 (such as inkjet, laser, or 3D printers), audio output devices 974 (such as speakers or headphones), text input devices 980 (such as keyboards), cursor control devices 982 for pointing and selection inputs (such as mice, trackballs, touch screens, joysticks, pointing sticks, electronic styluses, electronic pen tablets), audio input devices 984 (such as microphones or external audio players), video input devices 986 (such as video and still cameras, or external video players), image scanners 988, video cards (not shown), disks 906, network devices 920, and so on. The input/output ports 910 may include, for example, serial ports, parallel ports, and USB ports.

The computer 900 can operate in a network environment and thus may be connected to the network devices 920 via the I/O interfaces 918, and/or the I/O ports 910. Through the network devices 920, the computer 900 may interact with a network 960. Through the network, the computer 900 may be logically connected to remote computers 965. Networks with which the computer 900 may interact include, but are not limited to, a LAN, a WAN, and other networks.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S. C. § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S. C. § 101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S. C. § 101.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S. C. § 101.

To the extent that the term “includes” or “including” is employed in the detailed description or the claims, it is intended to be inclusive in a manner similar to the term “comprising”as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. A computer-implemented method, the method comprising:
receiving a ticket generated by an AI Chatbot for a guest of an establishment, the ticket configured to include a guest message;
determining, by a machine learning model, a task to be completed based on the guest message;
determining, by the machine learning model, one or more departments associated with the establishment for handling the task;
assigning, using an iterative algorithm, the generated ticket to one or more attendant devices for task completion, each attendant device belonging to a staff member of the establishment;
communicating, via the iterative algorithm, to the assigned one or more attendant devices, a request for completion of the task; and
displaying, on at least one of the assigned one or more attendant devices graphical user interface (GUI) display, an attendant dashboard for viewing one or more assigned tasks and the corresponding one or more generated tickets.

2. The method of claim 1, further comprising auto-assigning the ticket to one or more attendant devices for task completion, via the iterative algorithm, bypassing staff member or manager approval, wherein the iterative algorithm auto-assigns the ticket based on at least one of: an availability, the department concerned, a pre-executed task, and the time complexity for the one or more staff members, corresponding to the one or more attendant devices, to complete the task.

3. The method of claim 1, further comprising determining, via the iterative algorithm, a proximity of the one or more attendant devices to the guest and a current workload of the one or more staff members to determine which attendant device to assign the generated ticket and task.

4. The method of claim 1, further comprising configuring the ticket to include details of the determined one or more departments, one or more tasks that can be completed by each department of the determined one or more departments, and a list of attendant devices assigned to each of the determined one or more departments.

5. The method of claim 1, further comprising accessing a department database, by the iterative algorithm, to determine active attendant devices for assignment of the generated ticket and task to complete the task.

6. The method of claim 5, further comprising verifying, by the iterative algorithm, whether active attendant devices are present, and determining which of the active attendant devices has the least amount of assigned tasks.

7. The method of claim 6, further comprising assigning the generated ticket and task to the active attendant device with the least amount of assigned tasks.

8. The method of claim 7, further comprising storing and updating details of the ticket in a customer database and sending a notification to the active attendant device associated with the assigned task.

9. The method of claim 1, further comprising configuring the assigned ticket as pending task approval, wherein approval by the one or more assigned attendant devices or a manager device belonging to a manager of the establishment is required prior to communicating to one or more attendant devices the request for completion of the task.

10. The method of claim 1, further comprising requesting, based on an output of the machine learning model, additional data from the guest by the AI Chatbot for determining the one or more departments for handling the guest message.

11. The method of claim 1, further comprising closing the ticket upon completion of the task associated with the ticket, disabling edits and updates to the ticket, and storing the guest message, chat session, and a corresponding ticket data including images and time of creation, completion, status changes, ticket changes, task changes, and all ticket flags in a customer database.

12. The method of claim 11, further comprising requiring picture verification of the completion of the task from the assigned one or more attendant devices prior to closing the ticket, wherein the machine learning algorithm analyzes the verification picture and matches the verification picture details with the ticket details prior to closing the ticket.

13. The method of claim 1, further comprising generating the ticket in response to a verbal communication between the guest and the AI Chatbot, wherein the generated ticket is based on the verbal communication, and wherein the guest to AI Chatbot verbal communication includes at least one of a user query, a user request, and a verbal command.

14. The method of claim 1, further comprising communicating the generated ticket to all departments of the establishment to prioritize the guest, wherein when the guest associated with the generated ticket requests to talk to a manager, the AI Chatbot directly notifies all the managers of all departments through the notification on one or more manager devices with details and requests raised by the guest from the concerned room number, and wherein one or more managers can chat directly in real-time with the guest for their concern.

15. The method of claim 1, further comprising displaying visually, on another GUI display associated with a manager device, a manager dashboard, and displaying on the manager dashboard, all task complaints, paused task complaints, and resolved tasks; and all new, paused, and existing tickets assigned to the one or more attendant devices.

16. The method of claim 1, further comprising displaying visually, on another GUI display associated with a manager device, a manager dashboard, and displaying on the manager dashboard, options for editing tickets, reassigning a new ticket to one or more different attendant devices, and resuming a ticket in progress to one or more different attendant devices.

17. The method of claim 1, further comprising displaying visually, on another GUI display associated with a manager device, a manager dashboard, and displaying on the manager dashboard, real-time view of the tickets and the tasks added and updated.

18. The method of claim 1, further comprising displaying visually, on another GUI display associated with a manager device, a manager dashboard, and displaying on the manager dashboard, the guest message and one or more chat sessions between the AI Chatbot and the guest that generated the ticket.

19. The method of claim 1, further comprising displaying visually, on another GUI display associated with a manager device, a manager dashboard, and displaying on the manager dashboard, a progress on the task and a list of actions for managing the task, the list of actions including: view status of task, view issue with task, abort task, resume task, pause task, and reschedule task; wherein selecting the ticket will display all the details and changes of the ticket.

20. The method of claim 19, further comprising displaying visually, on another GUI display associated with a manager device, a manager dashboard, and displaying on the manager dashboard, at least one of the following associated with the ticket: one or more chat sessions between a manager and a staff member and one or more chat sessions between staff members.

21. The method of claim 1, further comprising receiving a cancel task from a manager dashboard of a manager device, and communicating to the assigned one or more attendant devices a notice to cancel completion of the task or receiving a pause task from the attendant's dashboard and communicating to the manager dashboard a notice that completion of the task has been paused.

22. The method of claim 21, further comprising updating the task with a pause case flag and a reason for pausing or cancelling completion of the task.

23. The method of claim 9, further comprising displaying on the attendant dashboard an option to select to complete the assigned task, update the status or progress of the assigned task, or request a manager approval for completing the assigned task corresponding to the generated ticket.

24. The method of claim 23, further comprising, in response to determining the attendant to have an active status, configuring the task to be approved and completable by the attendant.

25. The method of claim 23, further comprising displaying all details of the ticket upon determining the attendant to have an active status.

26. The method of claim 23, further comprising moving the ticket to a history section upon completion of a corresponding task for the ticket, wherein the completed ticket will not accept any changes.

27. The method of claim 25, further comprising displaying a ticket progress upon determining the attendant to have an active status.

28. The method of claim 23, further comprising requesting image verification or facial recognition of the attendant to determine the active status of the attendant.
